(19) United States
(12) Patent Application Publication
(10) Pub. No.: US 2022/0343430 A1
(43) Pub. Date: Oct. 27, 2022

(54) COMPUTATIONAL INVESTMENT PROPENSITY SCORING

(71) Applicant: Novation Solutions Inc., Toronto (CA)

(72) Inventors: Mark Yamashita, Toronto (CA); Jesus Geronimo De Abreu Romero, Toronto (CA)

(73) Assignee: Novation Solutions Inc., Toronto (CA)

(21) Appl. No.: 17/549,861

(22) Filed: Dec. 13, 2021

Related U.S. Application Data
(60) Provisional application No. 63/177,999, filed on Apr. 22, 2021.

(51) Int. Cl. G06Q 40/06; G06N 20/00

(52) U.S. Cl. CPC G06Q 40/06; G06N 20/00

(57) ABSTRACT

An aspect of the disclosed embodiments is a method for scoring a propensity of an entity to invest in a deal, such that a produced propensity score could be sold as a tangible asset. The method comprises receiving one or more datapoints about the entity; receiving one or more datapoints about the deal; and producing, by a processing device executing a machine learning model, a propensity score representing the propensity of the entity to invest in the deal by processing the one or more datapoints about the entity and the one or more datapoints about the deal, wherein the processing of the one or more datapoints about the entity comprises identifying similarities of the one or more datapoints about the entity with other datapoints about other entities, wherein the processing of the one or more datapoints about the deal comprises identifying similarities of the one or more datapoints about the deal with other datapoints about other deals, and the machine learning model is trained to determine the propensity of the entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment.

### CROSS-REFERENCE TO RELATED APPLICATION

This application claims priority to U.S. Provisional Patent Application Ser. No. 63/177,999 filed on Apr. 22, 2021, the contents of which are incorporated herein by reference.

### TECHNICAL FIELD

The following relates generally to machine learning models, and more particularly to computational systems, methods, and processes for training and operating machine learning models to quantify propensities of entities to invest in deals.

### BACKGROUND

Regulations permitting the public advertising and solicitation of investment deals provide numerous opportunities for issuers wishing to sell securities to finance their operations. For example, issuers may deploy marketing strategies that include the building of marketing funnels using advertising and invitations to potential investors and the tracking of these potential investors as they are migrated from intake to investment. Particularly those marketing strategies with an online component—such as those providing click through to a computer website hosting a deal—may be seamlessly integrated with the more formal investment requirements, including the online completion of an investor questionnaire, the automatic generation and execution of a digitally executable investment/subscription agreement, and engagement with electronic payment systems.

For example, DealMaker (Toronto, Canada) provides an online platform for facilitating private placement deals. Investors may be invited through the platform, for example via an email containing a deal-individualized web link, to consider a particular deal being offered by an issuer, to complete a questionnaire and otherwise to move towards completing an investment in the deal. Information provided via such a questionnaire may include personal information, investment specifics, and any information appropriate to the deal being issued. Based on the information collected as part of the questionnaire, and the features of the deal itself, a subscription/agreement document is automatically generated. The investor may digitally sign the subscription/investment agreement and, once signed, the investor may be directed to pay for the investment using an available payment option.

Online facilitation of deals can be seamlessly integrated with scaled online marketing funnels through electronic messaging and online advertising. This may more easily enable very large numbers of potential investors—thousands and tens of thousands of potential individual investors—to enter into a deal's funnel, thereby enabling each of these potential investors to be exposed to deals.

However, once the large numbers of potential investors are in a deal funnel, it can be very difficult for an issuer to distinguish “signal” from “noise”. In particular, it can be very difficult for an issuer to discern which potential investors are worth directing an issuer's limited deal resources such as time, attention and money, in order to coax the potential investors to complete their investment. With very large numbers of potential investors in an online-facilitated funnel for a deal, this challenge is significantly exacerbated: the number of potential investors in the funnel out scales an issuer's limited marketing and deal resources if the issuer is planning to treat all potential investors in the funnel equally. Treating all investors in a very large funnel in a careful manner that is sufficiently encouraging for those who are more likely to invest can be extremely expensive and can result in a significant waste of deal resources on those who, despite the careful treatment, are not likely to invest. Similarly, treating all investors in a very large funnel in a manner that is not even sufficient for those who are more likely to invest can save money overall but fail to convert a sufficient number of even those who are more likely to invest into actual investors. There is therefore a need, particular for very large deal funnels, to distinguish in an intelligent manner those entities who are more inclined to be potential investors on a particular deal from those who are less inclined to be potential investors on the deal, so that deal resources can be differentially deployed. There is also a need to automate in an intelligent manner interventions directed at entities who are potential investors in a deal thereby to assist the potential investors to complete their investment.

### SUMMARY

An aspect of the disclosed embodiments is a method for scoring a propensity of an entity to invest in a deal, the method comprising: receiving one or more datapoints about the entity; receiving one or more datapoints about the deal; and producing, by a processing device executing a machine learning model, a propensity score representing the propensity of the entity to invest in the deal by processing the one or more datapoints about the entity and the one or more datapoints about the deal, wherein the processing of the one or more datapoints about the entity comprises identifying similarities of the one or more datapoints about the entity with other datapoints about other entities, wherein the processing of the one or more datapoints about the deal comprises identifying similarities of the one or more datapoints about the deal with other datapoints about other deals, and the machine learning model is trained to determine the propensity of the entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment.

In embodiments, each of the one or more datapoints about the entity is respectively one of: a demographic datapoint, a personal datapoint, an investment history datapoint, and an entity-deal datapoint.

In embodiments, each demographic datapoint is respectively one of: a location, whether the entity is an organization or an individual, an age, a date of birth, and a gender.

In embodiments, each personal datapoint is respectively one of: an email domain, a risk aversion level, an investment aim, a net worth, an income, whether the entity is an accredited investor, and whether the entity is eligible to make a particular class of investment.

In embodiments, each investment history datapoint is respectively one of: whether the entity has invested before, a type of prior investment, an amount of prior investment, a type of prior investment passed on, and a number of investment deals to which the entity has previously been invited.

In embodiments, each entity-deal datapoint is respectively one of: whether the entity was invited to consider the deal, at what stage in closing the deal the entity has reached, an entity relationship to an issuer of the deal, in how many saleable units of the deal the entity has expressed interest, whether the entity has invested in the issuer of the deal, whether the entity has a broker for the deal, a number of past issuances dealt with using the broker, a payment method for the deal, and a deal portal interaction datapoint.

In embodiments, each deal portal interaction datapoint is respectively one of: a time spent by a user reviewing the deal via a network-accessible deal portal, a time spent by the user reviewing particular aspects of the deal via the deal portal, a time delay between completing stages of a deal questionnaire via the deal portal, a time of day at which the user has accessed the deal portal, and a frequency with which the user has accessed the deal portal.

In embodiments, the method includes generating, for presentation on a computing device, a user interface element including a representation of the propensity score in association with identifying information about the entity.

In embodiments, the method includes assigning the entity to a first cohort based at least in part on the propensity score.

In embodiments, the method includes generating, for presentation on a computing device, a user interface element including an identification of entities as being assigned to the first cohort.

In embodiments, the method includes providing, as part of the user interface element, a user interface control for enabling messaging of one or more entities assigned to the first cohort.

In embodiments, the method includes, at least once: receiving one or more additional or modified datapoints about the entity; and repeating the producing using the one or more additional or modified datapoints thereby to produce an updated propensity score.

In embodiments, the method includes: responsive to the updated propensity score being at least a threshold amount different from the propensity score or a previous updated propensity score, re-assigning the entity to a second cohort.

In embodiments, entities assigned to the second cohort have higher propensities to invest in the deal than entities assigned to the first cohort.

In embodiments, entities assigned to the first cohort have higher propensities to invest in the deal than entities assigned to the second cohort.

In embodiments, the method includes responsive to the re-assigning, generating, for presentation on a computing device, a report about the re-assigning.

In embodiments, the report about the re-assigning comprises information derived from one or more differences between values of the one or more additional or modified datapoints about the entity and the one or more datapoints about the entity, thereby to emphasize cause(s) of the re-assigning to the second cohort.

An aspect of the disclosed embodiments is a tangible, non-transitory computer-readable medium storing instructions that, when executed by a processing device, cause the processing device to perform the steps of the method.

An aspect of the disclosed embodiments is a system, comprising: a memory device storing instructions; and a processing device communicatively coupled to the memory device, wherein the processing device executes the instructions to perform the steps of the method.

An aspect of the disclosed embodiments is method for generating a profile of an entity with a high propensity to invest in a deal, the method comprising: receiving one or more datapoints about the deal; and producing, by a processing device executing a machine learning model, an entity profile containing one or more datapoints about an entity by processing the one or more datapoints about the deal, wherein the processing of the one or more datapoints about the deal comprises identifying similarities of the one or more datapoints about the deal with other datapoints about other deals, and the machine learning model is trained to determine the one or more datapoints about the entity using input data comprising: (i) other datapoints about other entities, (ii) the other datapoints about the other deals, (iii) feedback about in which of the other deals the other entities had completed an investment, and (iv) feedback about in which of the other deals the other entities had not completed an investment.

In embodiments, at least one of the one or more datapoints about the entity is a range of values.

An aspect of the disclosed embodiments is a tangible, non-transitory computer-readable medium storing instructions that, when executed by a processing device, cause the processing device to perform the steps of the method.

An aspect of the disclosed embodiments is a system, comprising: a memory device storing instructions; and a processing device communicatively coupled to the memory device, wherein the processing device executes the instructions to perform the steps of the method.

An aspect of the disclosed embodiments is a method for ranking candidate entity profiles based on propensity to invest in a deal, the method comprising: receiving multiple candidate entity profiles each comprising one or more datapoints about a respective candidate entity; receiving one or more datapoints about the deal; and for each of the multiple candidate entity profiles: producing, by a processing device executing a machine learning model, a propensity score representing the propensity of the respective entity to invest in the deal by processing the one or more datapoints about the respective entity and the one or more datapoints about the deal, wherein the processing of the one or more datapoints about the respective entity comprises identifying similarities of the one or more datapoints about the respective entity with other datapoints about other entities, wherein the processing of the one or more datapoints about the deal comprises identifying similarities of the one or more datapoints about the deal with other datapoints about other deals, and the machine learning model is trained to determine the propensity of the respective entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment; the method further comprising: ranking the candidate entity profiles based on the respective propensity scores.

An aspect of the disclosed embodiments is a tangible, non-transitory computer-readable medium storing instructions that, when executed by a processing device, cause the processing device to perform the steps of the method.

An aspect of the disclosed embodiments is a system, comprising: a memory device storing instructions; and a processing device communicatively coupled to the memory device, wherein the processing device executes the instructions to perform the steps of the method.

An aspect of the disclosed embodiments is a method for predicting a total amount of investment in a deal by a group of entities, the method comprising: receiving one or more datapoints for each of a plurality of entities in the group, wherein the one or more datapoints for each of the plurality of entities in the group comprises an investment amount expressed by the entity; receiving one or more datapoints about the deal; and for each of the plurality of entities in the group: producing, by a processing device executing a machine learning model, a propensity score representing the propensity of the respective entity to invest in the deal by processing the one or more datapoints about the respective entity and the one or more datapoints about the deal, wherein the processing of the one or more datapoints about the respective entity comprises identifying similarities of the one or more datapoints about the respective entity with other datapoints about other entities, wherein the processing of the one or more datapoints about the deal comprises identifying similarities of the one or more datapoints about the deal with other datapoints about other deals, and the machine learning model is trained to determine the propensity of the respective entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment; the method further comprising: for each of the plurality of entities in the group, generating an entity predicted investment amount based on the investment amount expressed by the entity and the propensity score for the entity, wherein the predicted total amount of investment by the group of entities in the deal is a sum of the entity predicted investment amounts of the plurality of entities in the group.

An aspect of the disclosed embodiments is a tangible, non-transitory computer-readable medium storing instructions that, when executed by a processing device, cause the processing device to perform the steps of the method.

An aspect of the disclosed embodiments is a system, comprising: a memory device storing instructions; and a processing device communicatively coupled to the memory device, wherein the processing device executes the instructions to perform the steps of the method.

These and other aspects of the present disclosure are provided in the following detailed description of the embodiments, the appended claims, and the accompanying figures.

### BRIEF DESCRIPTION OF THE DRAWINGS

FIG. 1 illustrates a high-level component diagram of an illustrative system architecture, according to an embodiment of this disclosure;

FIG. 2 illustrates a component diagram of components of the system architecture of FIG. 1 pertaining to the creation of a deal profile for storage on a cloud-based computing system;

FIG. 3 illustrates a user interface showing user interface elements presented to a user of a computing device as a deal form for entering datapoints pertaining to the deal profile;

FIG. 4 illustrates a user interface showing user interface elements presented to a user of a computing device for confirming the datapoints pertaining to the deal profile and creating the deal profile;

FIG. 5 illustrates a user interface showing user interface elements presented to a user of a computing device for viewing the deal profile and user interface controls for executing functions pertaining to the deal profile and to a current funnel of entities associated with the deal;

FIG. 6 illustrates a component diagram of components of the system architecture of FIG. 1 pertaining to the creation of an entity profile and of an entity-deal profile and a propensity score for the entity for storage on the cloud-based computing system;

FIG. 7 illustrates a user interface showing user interface elements presented to a user of a computing device as a landing/deal profile introduction page reached after a user has responded to an invitation to invest in a deal;

FIG. 8 illustrates a user interface showing user interface elements presented to a user of a computing device enabling the user to sign into a deal portal hosting the deal profile of the deal to which the invitation pertained;

FIG. 9 illustrates a user interface showing user interface elements presented to a user of a computing device enabling the user to review the deal to which the invitation pertained;

FIG. 10 illustrates a user interface showing user interface elements presented to a user of a computing device enabling the user to begin completing steps of a questionnaire thereby to enter one or more datapoints about an entity—the user itself or another entity—that may invest in the deal;

FIG. 11 illustrates a user interface showing user interface elements presented to a user of a computing device enabling the user to continue through the steps of the questionnaire;

FIG. 12 illustrates a user interface showing another user interface elements presented to a user of a computing device enabling the user to continue through the steps of the questionnaire;

FIG. 13 illustrates a user interface showing another user interface elements presented to a user of a computing device enabling the user to continue through the steps of the questionnaire;

FIG. 14 illustrates a user interface showing another user interface elements presented to a user of a computing device enabling the user to continue through the steps of the questionnaire;

FIG. 15 illustrates a user interface showing another user interface elements presented to a user of a computing device enabling the user to continue through the steps of the questionnaire;

FIG. 16 illustrates a user interface showing another user interface elements presented to a user of a computing device enabling the user to continue through the steps of the questionnaire;

FIG. 17 illustrates a user interface showing another user interface elements presented to a user of a computing device enabling the user to continue through the steps of the questionnaire;

FIG. 18 illustrates a user interface showing another user interface elements presented to a user of a computing device enabling the user to continue through the steps of the questionnaire;

FIG. 19 illustrates a user interface showing another user interface elements presented to a user of a computing device enabling the user to continue through the steps of the questionnaire;

FIG. 20 illustrates a user interface showing another user interface elements presented to a user of a computing device enabling the user to continue through the steps of the questionnaire;

FIG. 21 illustrates a user interface showing user interface elements presented to a user of a computing device enabling the user to review the one or more datapoints the user entered into the questionnaire;

FIG. 22 illustrates a user interface showing user interface elements presented to a user of a computing device enabling the user to review and begin the processing of digitally executing an investment/subscription agreement automatically generated in accordance with one or more datapoints about the deal and one or more datapoints about the entity;

FIG. 23 illustrates a user interface showing user interface elements presented to a user of a computing device enabling the user to review their digital execution of the investment/subscription agreement;

FIG. 24 illustrates a user interface showing user interface elements presented to a user of a computing device enabling the user to confirm agreement of their digital execution of the investment/subscription agreement;

FIG. 25 illustrates a user interface showing user interface elements presented to a user of a computing device enabling the user to begin the processing of payment in accordance with the executed investment/subscription agreement;

FIG. 26 illustrates a user interface showing user interface elements presented to a user of a computing device enabling the user to upload additional documents, as required, for provision to the issuer along with the executed investment/subscription agreement;

FIG. 27 illustrates a user interface showing user interface elements presented to a user of a computing device enabling the user to review the investment summary, including status of payments and/or other requirements to complete the investment in the deal;

FIG. 28 is an example block diagram of training a machine learning model(s) to output, based on data pertaining to one or more datapoints about a deal and one or more datapoints about an entity, a propensity score representing the propensity of the entity to invest in the deal;

FIG. 29 is an example block diagram of training a machine learning model(s) to output, based on data pertaining to one or more datapoints about a deal, a prediction of kinds of entities likely to have high propensities to invest in the deal;

FIG. 30 is an example block diagram of training a machine learning model(s) to output, based on data pertaining to one or more datapoints about each of multiple different kinds of entities and one or more datapoints about the deal, a prediction of a ranking of the propensities of the different kinds of entities to invest in the deal;

FIG. 31 is an example block diagram of training a machine learning model(s) to output, based on data pertaining to one or more datapoints about each of multiple entities in a group comprising an investment amount expressed by each entity and one or more datapoints about a deal, a prediction of a total amount of investment in the deal by the group of entities;

FIG. 32 illustrates an example block diagram of receiving one or more additional or modified datapoints about the entity according to certain embodiments of this disclosure;

FIG. 33 illustrates an example block diagram of performing one or more interventions according to certain embodiments of this disclosure;

FIG. 34 illustrates a user interface showing user interface elements presented to a user of a computing device enabling the user to review a deal profile for a deal hosted on the deal portal and including user interface controls enabling the user to view entity invitations to the deal, a current funnel of entities associated with the deal, and/or a report on entities in the current funnel who may be stalled on executing payment for completing their investment;

FIG. 35 illustrates a user interface showing user interface elements presented to a user of a computing device enabling the user to view a high propensity cohort of a current funnel of entities associated with the deal, and a user interface control for enabling the user to message the high propensity cohort;

FIG. 36 illustrates a user interface showing user interface elements presented to a user of a computing device enabling the user to view a medium propensity cohort of a current funnel of entities associated with the deal, and a user interface control for enabling the user to message the medium propensity cohort;

FIG. 37 illustrates a user interface showing user interface elements and user interface controls presented to a user of a computing device enabling the user to select a cohort of a current funnel of entities associated with the deal, including a cohort of entities that have recently shifted, due to a change in respective propensity score, from a medium propensity cohort to a high propensity cohort or a cohort of entities that have recently shifted, due to a change in respective propensity score, from a high propensity cohort to a medium propensity cohort;

FIG. 38 illustrates steps in a method for scoring a propensity of an entity to invest in a deal, according to embodiments;

FIG. 39 illustrates steps in a method for generating a profile of an entity with a high propensity to invest in a deal, according to embodiments;

FIG. 40 illustrates steps in a method for ranking candidate entity profiles based on propensity to invest in a deal;

FIG. 41 illustrates steps in a method for predicting a total amount of investment in a deal by a group of entities; and

FIG. 42 illustrates an example computer system.

Other aspects and embodiments will become apparent upon reading the following description.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” In addition, the term “couple” or “couples” is intended to mean either an indirect or a direct connection. Thus, if a first device couples to a second device, that connection may be through a direct connection or through an indirect connection via other devices and connections.

The terminology used herein is for describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

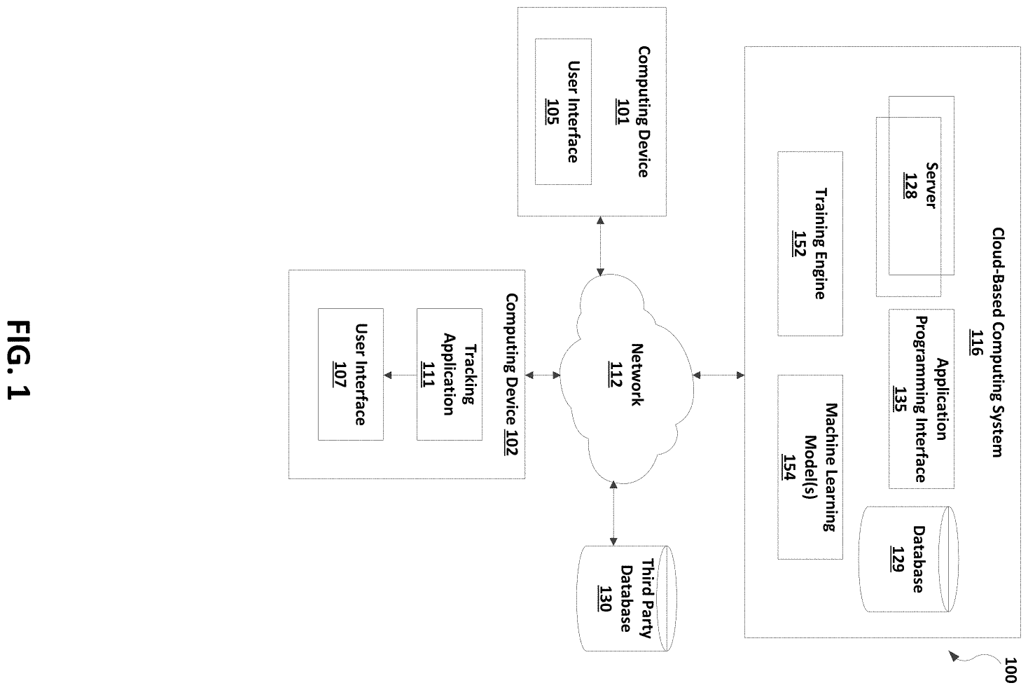

FIG. 1 illustrates a high-level component diagram of an illustrative system architecture 100 according to an embodiment of this disclosure. In this embodiment, system architecture 100 includes a computing device 101, a computing device 102, a cloud-based computing system 116, and/or a third party database 130, communicatively coupled via a network 112. As used herein, a cloud-based computing system refers, without limitation, to any remote or distal computing system accessed over a network link. Each of computing device 101 and computing device 102 may include one or more processing devices, memory devices, and network interface devices.

In some embodiments, the network interface devices of computing devices 101 and 102 enable communication via a wireless protocol for transmitting data over short distances, such as Bluetooth, ZigBee, near field communication (NFC), etc. Additionally, the network interface devices may enable communicating data over long distances. In this embodiment, computing devices 101 and/or 102 communicate with network 112. Network 112 may be a public network (e.g., connected to the Internet via wired (Ethernet) or wireless (Wi-Fi)), a private network (e.g., a local area network (LAN), wide area network (WAN), virtual private network (VPN)), or a combination thereof.

Communications or portions or payloads thereof that are conveyed between devices and/or stored electronically may be encrypted using an encryption technology such as AES (Advanced Encryption System) 256-bit encryption.

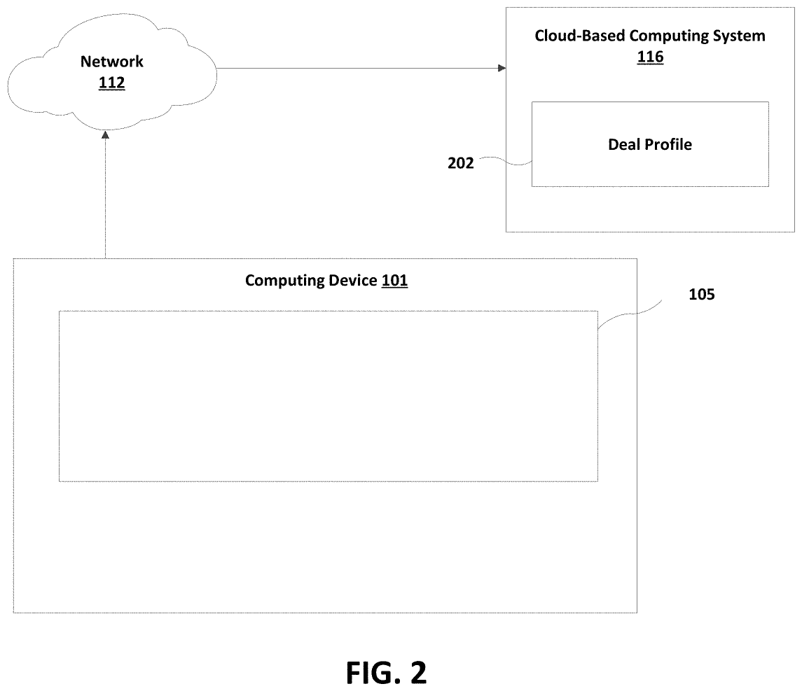

FIG. 2 illustrates a component diagram of components of system architecture 100 pertaining to the creation of a deal profile 202 for storage on cloud-based computing system 116. In this embodiment, computing device 101 may be any suitable computing device, such as a laptop, tablet, smartphone, or computer, configured as will be described as a special purpose machine to function as described herein. In this embodiment, computing device 101 includes a display that is capable of presenting a user interface 105. In this embodiment, computing device 101 is operable by a user who is representing an issuer such as an organization. User interface 105 may be implemented in computer instructions stored on a memory of computing device 101 and executed by a processing device of computing device 101. User interface 105 may be a stand-alone application that is installed on computing device 101 or may be an application (e.g., website) that executes via a web browser that is itself installed on computing device 101. User interface 105 may present various forms, screens, notifications, user interface elements, user interface controls, and/or messages to a user. Such forms may contain various user interface elements such as text/number entry boxes, radio buttons, checkboxes, dropdowns and the like. These user interface elements enable a user of user interface 105 to enter information in the form of text, numbers, option selections, and the like thereby to enter one or more datapoints about a deal to be issued by an issuer. For example, FIG. 2 illustrates a component diagram of components of system architecture 100 pertaining to the creation of a deal profile 212 for storage on cloud-based computing system 116. A user of computing device 101 may complete a deal form presented via user interface 105 by submitting datapoints about the deal in the deal form thereby to store deal profile 212 on cloud-based computing system 116.

Datapoints about a deal may each be deal issuer datapoints, a deal price per security, a regulation type (such as: Reg A, Reg D, Reg CF, etc.), a security type (such as: share, bond, etc.), a currency, a number of reminders to investors the issuer wishes to send each week, and/or some other datapoints about the deal.

Deal issuer datapoints in particular may include datapoints about the issuer itself, such as issuer name, issuer industry, issuer size (for example, value of sales and/or number of employees), number of deals the issuer has issued in the past, whether the issue is a privately or publicly held company, and/or some other deal issuer datapoints. While datapoints about a deal may be entered by a user into a deal form via user interface 105, in some embodiments datapoints about a deal may be gleaned from other sources under the authorization of the user. For example, deal issuer datapoints constituting an issuer profile may be stored in database 129 on cloud-based computing system under the control of the deal portal, and/or in a third-party database 130 accessible through network 112, and may be accessed for pre-populating a deal form.

Datapoints about a deal may be stored collectively as part of a deal profile that may be hosted on a deal portal accessible via cloud-based computing system 116. The deal profile may be made accessible to other users, such as a user of computing device 102. Portions of a deal profile may be maintained in confidence with respect to certain other users.

User interface 105 may interface with an application programming interface 135 (API) of the cloud-based computing system 116. For example, the API 135 may be used to provide one or more user interface elements and/or user interface controls that is/are embedded in a screen of the user interface 105.

User interface 105 may communicate and/or store textual/numerical/option selection input separately from information personally identifying the user who has entered it. The user interface may communicate and/or store textural/numerical/option selection input separate from information identifying the issuer to which the input pertains. Any linkage between the user or issuer and their information may be provided only to an authorized user or users, such a representative of the issuer itself, a regulator, or the like. In this way, a user entering one or more datapoints can be provided with additional reassurance that personally identifying information is not available to anyone else.

It will be appreciated that system architecture 100 may accommodate multiple computing devices functioning in a similar manner to computing device 101, each operable by respective users in respect of the same or different deals, and in respect of the same or different entities considering investing in deals. For example, a first authorized user may be using a computing device such as computing device 101 to create a first deal profile for a first deal and to track investments and prospective investments by entities who are considering investing in the first deal. The same first authorized user may be using the same or a different computing device such as computing device 101 to create a second deal profile for a second deal and to track investments and prospective investments by entities who are considering investing in the second deal. A second authorized user may be using the same or a different computing device such as computing device 101 to access the first deal profile and to track the first deal. Such a second authorized user may not be authorized to access the second deal profile and to track the second deal. Permissions to view/access deal profiles and to engage with other functionality such as the ability to view details about an investment funnel and to track deals may be managed using user profiles and security for such user profiles involving access management configurations controlled by the deal portal.

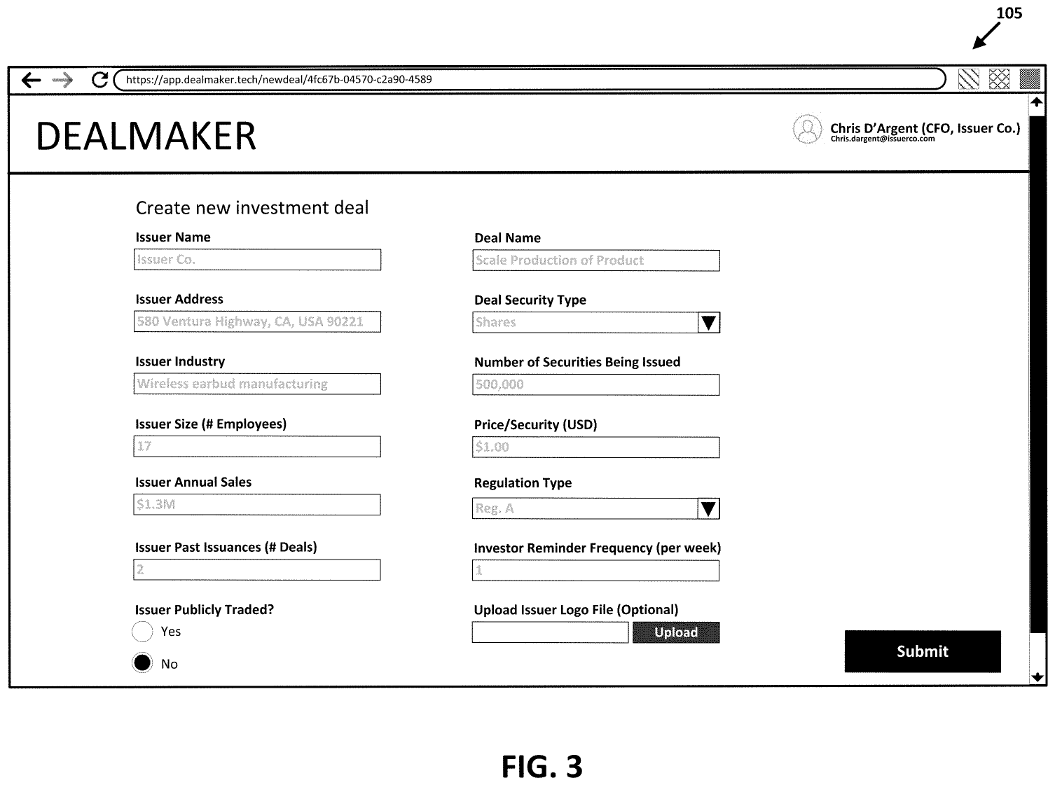

FIG. 3 illustrates user interface 105 showing user interface elements presented to a user of computing device 101 as a deal form for entering datapoints pertaining to the deal profile 202.

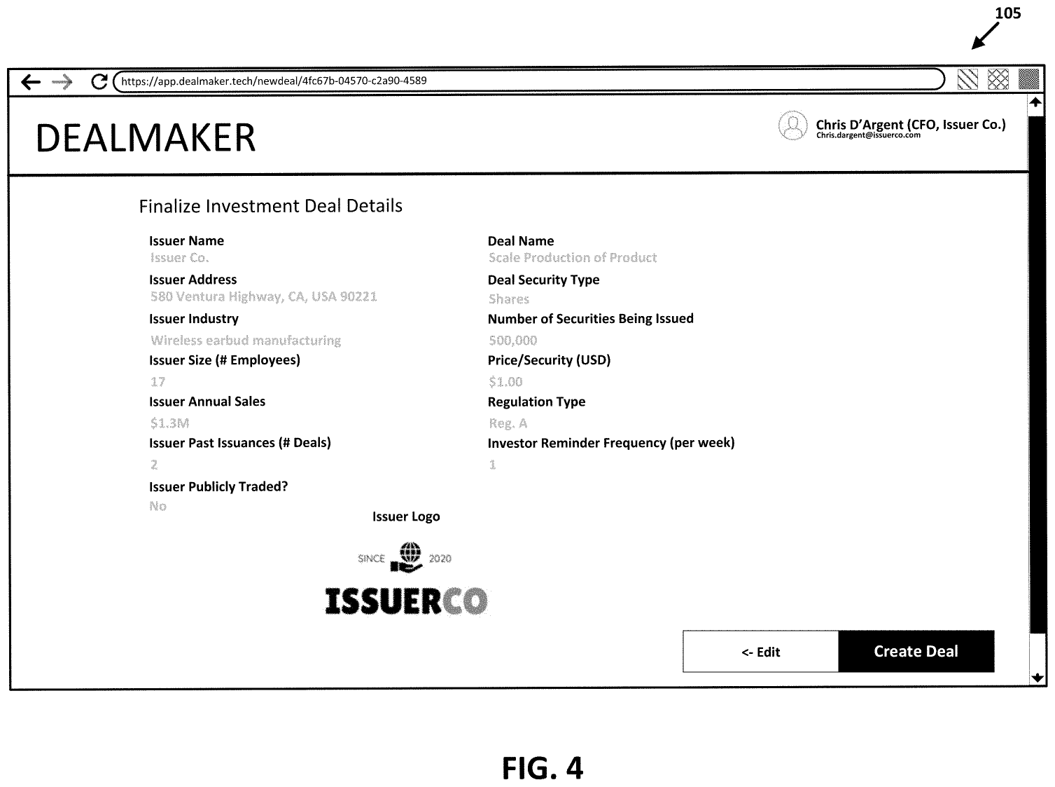

FIG. 4 illustrates user interface 105 showing user interface elements presented to a user of computing device 101 for confirming the datapoints pertaining to the deal profile 202 and creating the deal profile 202.

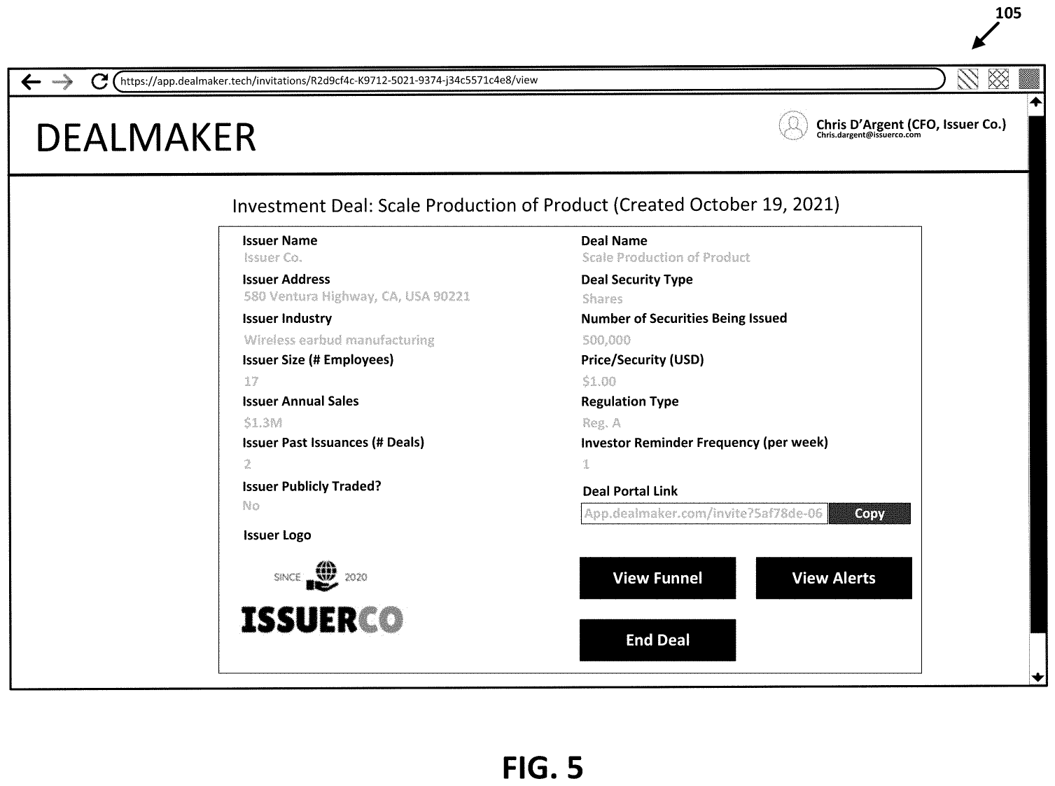

FIG. 5 illustrates user interface 105 showing user interface elements presented to a user of computing device 101 for viewing the deal profile 202 and user interface controls for executing functions pertaining to the deal profile 202 and to a current funnel of entities associated with the deal.

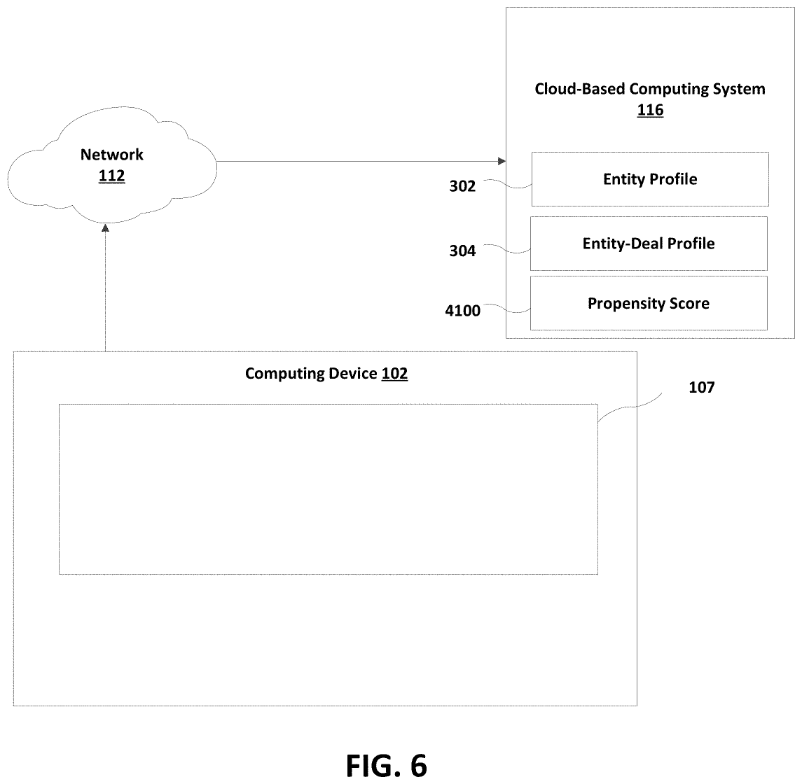

FIG. 6 illustrates a component diagram of components of system architecture 100 pertaining to the creation of an entity profile 302 and of an entity-deal profile 304 for storage on cloud-based computing system 116, and a propensity score 4100 for the entity. In this embodiment, computing device 102 may be any suitable computing device, such as a laptop, tablet, smartphone, or computer, configured as will be described as a special purpose machine to function as described herein. In this embodiment, computing device 102 includes a display that is capable of presenting a user interface 107. In this embodiment, computing device 102 is operable by a user who is an entity considering investing in a deal, or is an authorized representative of such an entity. It will be appreciated that, in this description, an entity is either a person or a juristic entity such as a corporation or other organization that is permitted to complete an investment. User interface 107 may be implemented in computer instructions stored on a memory of computing device 102 and executed by a processing device of computing device 102. User interface 107 may be a stand-alone application that is installed on computing device 102 or may be an application (e.g., website) that executes via a web browser that is itself installed on computing device 102. User interface 107 may present various forms, screens, notifications, user interface elements, user interface controls, and/or messages to a user. Such forms may contain various user interface elements such as text/number entry boxes, radio buttons, checkboxes, dropdowns and the like. These user interface elements may enable a user of user interface 107 to enter information in the form of text, numbers, option selections, and the like thereby to enter one or more datapoints about the entity and about the entity's proposed relationship to the deal (such as a selected number of securities offered in the deal that the entity is contemplating purchasing) that can be stored as an entity-deal profile hosted on a deal portal on cloud-based computing system 116. For example, a user may complete an entity questionnaire in connection with a deal by entering datapoints in response to particular questions about the entity and about the entity's proposed relationship to the deal.

Datapoints about an entity may each respectively be demographic datapoints, personal datapoints, an investment history datapoint, an entity-deal datapoint, or some other kind of datapoint about the entity.

Demographic datapoints in particular may include datapoints about the demographics of the entity, such as a location, whether the entity is an organization or an individual, an age, a date of birth, a gender, and/or some other demographic datapoint.

Personal datapoints in particular may include datapoints about the entity in particular, such as an email domain, a risk aversion level, an investment aim, a net worth, an income, whether the entity is an accredited investor, whether the entity is eligible to make a particular class of investment (such as Reg D, Reg A, Reg CF, or some other class of investment pertinent to the jurisdiction in question) as an individual or as a juristic entity, and/or some other personal datapoint. Whether the entity is an accredited investor may be further qualified by whether the entity is an accredited individual Canadian investor, an accredited individual US or other country investor, an accredited juristic/corporate Canadian investor, and/or an accredited juristic/corporate US or other country investor.

Investment history datapoints in particular may include datapoints about the entity's investment history, such as whether the entity has invested before, a type of prior investment, an amount of prior investment, a type of prior investment passed on, a number of investment deals to which the entity has previously been invited, and/or some other investment history datapoint.

Entity-deal datapoints in particular may include datapoints about the entity's relationship to the deal, such as whether the entity was invited to consider the deal, at what stage in closing the deal the entity has reached, an entity relationship to an issuer of the deal (insider, friends/family, etc.), in how many saleable units of the deal the entity has expressed interest, whether the entity has invested in the issuer of the deal, whether the entity has a broker for the deal, a number of past issuances dealt with using the broker, a payment method for the deal, and a deal portal interaction datapoint.

A deal portal interaction datapoint in particular may include datapoints about a user's interaction with a deal portal in connection with a deal, such as a time spent by a user reviewing the deal via a network-accessible deal portal, a time spent by the user reviewing particular aspects of the deal via the deal portal, a time delay between completing stages of a deal questionnaire via the deal portal, a time of day at which the user has accessed the deal portal, a frequency with which the user has accessed the deal portal, and/or some other deal portal interaction datapoint.

While some datapoints about an entity may be entered by a user into a deal form via user interface 107, in some embodiments datapoints about an entity may be gleaned from other sources under the authorization of the user. For example, entity datapoints constituting an entity profile may be stored in database 129 on cloud-based computing system under the control of the deal portal, and/or in a third-party database 130 accessible through network 112, and may be accessed for pre-populating a questionnaire.

For example, an entity may have a pre-entered entity profile stored on cloud-based computing system 116, and an entity-deal profile may be created when an entity engages in some manner with a deal, such as by accepting an invitation to consider investing in the deal. An entity-deal profile may be at least partially completed, subject to edits by a user, using data from the entity profile. An entity profile and/or an entity-deal profile may be accessible to other authorized users, such as users representing an issuer of a deal. Portions of an entity profile and/or of an entity-deal profile may be maintained in confidence with respect to certain other users.

The screens, notifications, and/or messages may encourage and/or guide the user of computing device 102 to contact the user of the computing device 101 by emailing, texting, voice calling, video calling or otherwise communicating with the user of computing device 101 regarding progress towards completing investment in a deal. In an embodiment, such encouragement may indicate that the user of computing device 102 could consider seeking guidance or additional information to help the user of computing device 102 towards completing an investment in a deal, as will be described. In an embodiment, notifications may provide a user of computing device 102 with information about a stage at which the user of computing device 102 has reached, to date, on the way towards completing an investment in a deal. The screens may provide a user of computing device 102 with information about its own propensity (or, as appropriate, that of the entity the user is authorized to represent) to invest in a deal, as will be described. Furthermore, as will be described, the screens, notifications and/or messages may provide a user of computing device 102 with information about change(s), over time, in their own propensity (or, as appropriate, that of the entity the user is authorized to represent) to invest in a deal. Furthermore, the user interface controls may include buttons, links or other controls for enabling a user of computing device 102 to take actions to intervene with respect to a user of computing device 101, such as for example to automatically or manually message the user of computing device 101.

The user interface 107 may interface with the application programming interface 135 (API) of the cloud-based computing system 116. For example, the API 135 may be used to provide one or more user interface elements and/or user interface controls that is/are embedded in a screen of the user interface 107.

The user interface 107 may communicate and/or store textual/numerical/option selection input separately from information personally identifying the user who has entered it. The user interface may communicate and/or store textural/numerical/option selection input separate from information identifying the entity to which the input pertains. Any linkage between the user or entity and their information may be provided only to an authorized user or users, such as an issuer of a deal, a regulator, or the like. In this way, a user entering one or more datapoints can be provided with additional reassurance that personally identifying information is not available to anyone else.

It will be appreciated that system architecture 100 may accommodate multiple computing devices functioning in a similar manner to computing device 102, each operable by respective users in respect of the same or different deals. For example, a user may be using a computing device such as computing device 102 to access a first deal profile for a first deal and to progress towards the user completing an investment in the first deal by completing a questionnaire and taking other steps. The same user may be using the same or a different computing device such as computing device 102 to access a second deal profile for a second deal and to progress towards the user completing an investment in the second deal by completing a questionnaire and taking other steps. A different user may be using the same or a different computing device such as computing device 102 to access the first deal profile and to progress towards the different user completing an investment in the first deal by completing a questionnaire and taking other steps. Such a different user may not be invited to or otherwise authorized to access the second deal profile and to progress towards the different user completing an investment in the second deal. Permissions to view deal profiles and to progress towards completing an investment in respective deals may be managed using user profiles and security for such user profiles involving access management configurations controlled by the deal portal.

Another party and/or system may be granted access to one or more datapoints provided by a user, provided automatically from a third party database such as third party database 130, provided by a database of cloud-based computing system 116, or otherwise provided. For example, cloud-based computing system 116 may be provided with access to datapoints, such as text, numbers, and option selections entered by the user, for the purpose of training machine learning models 154. A user may be provided with reassurance that any of the user's data used for training is stored securely and/or is deleted once training of machine learning models 154 using the user's data is complete.

With respect in particular to deal portal interaction datapoints, computing device 102 may also execute a tracking application 111 to automatically capture and transmit deal portal interaction datapoints. Tracking application 111 may be implemented in computer instructions stored on the one or more memory devices of computing device 102 and executable by the one or more processing devices of computing device 102. Tracking application 111 may be provided by the cloud-based computing system 116. Tracking application 111 may automatically monitor aspects of the interaction by the user with user interface 107 and automatically transmit deal portal interaction datapoints to the cloud-based computing system 116. Tracking application 111 may transmit the deal portal interaction datapoints to the cloud-based computing system 116 in association with a particular deal in respect of which a user is interacting with user interface 107, or may transmit deal portal interaction datapoints to the cloud-based computing system 116 more generally i.e., without associating the deal portal interaction datapoints with a particular deal.

In some embodiments, functions of tracking and capture of deal portal interaction datapoints may be implemented on server(s) 128 of cloud-based computing system 116. For example, particular page requests made via a browser application executing on computing device 102, and/or times between such page requests, and other such interactions, may be suitable as deal portal interaction datapoints.

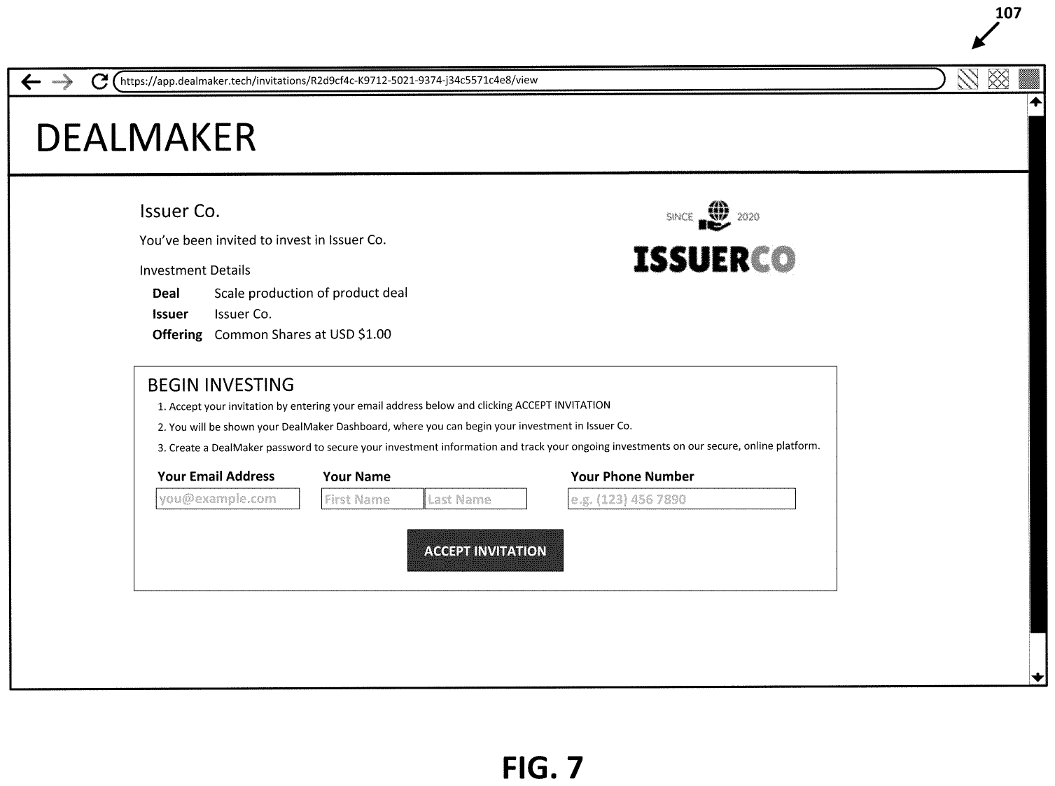

FIG. 7 illustrates user interface 107 showing user interface elements presented to a user of computing device 102 as a landing/deal profile introduction page reached after a user has responded to an invitation to invest in a deal.

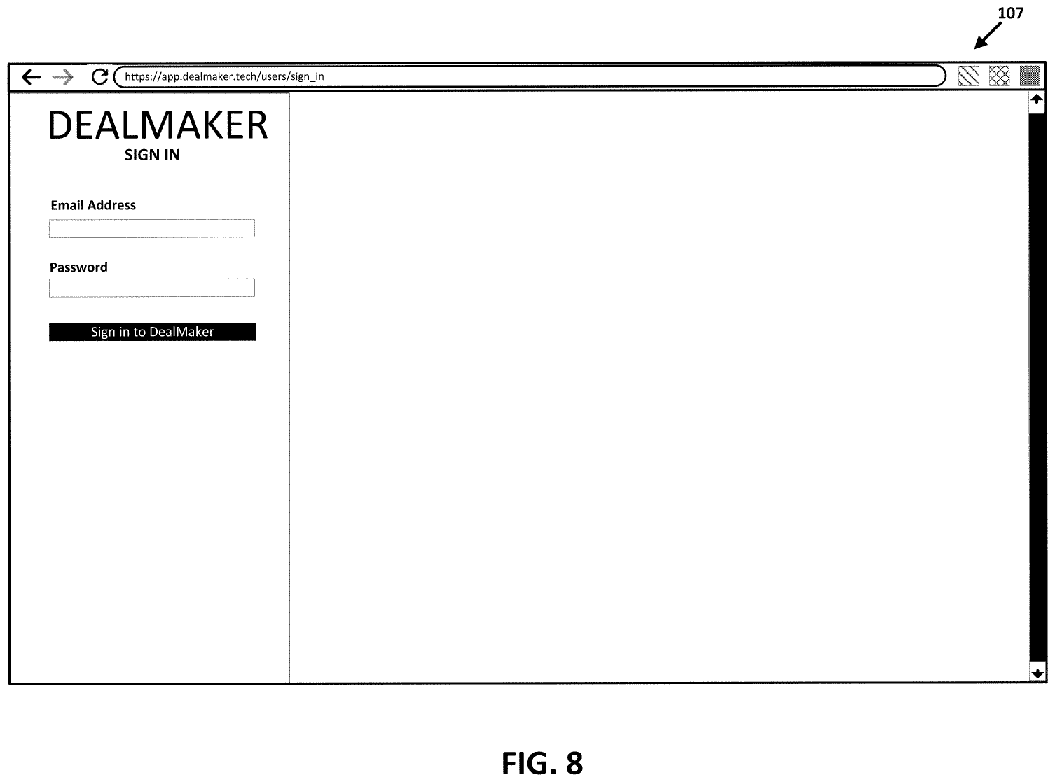

FIG. 8 illustrates user interface 107 showing user interface elements presented to a user of computing device 102 enabling the user to sign into a deal portal hosting the deal profile 202 of the deal to which the invitation pertained.

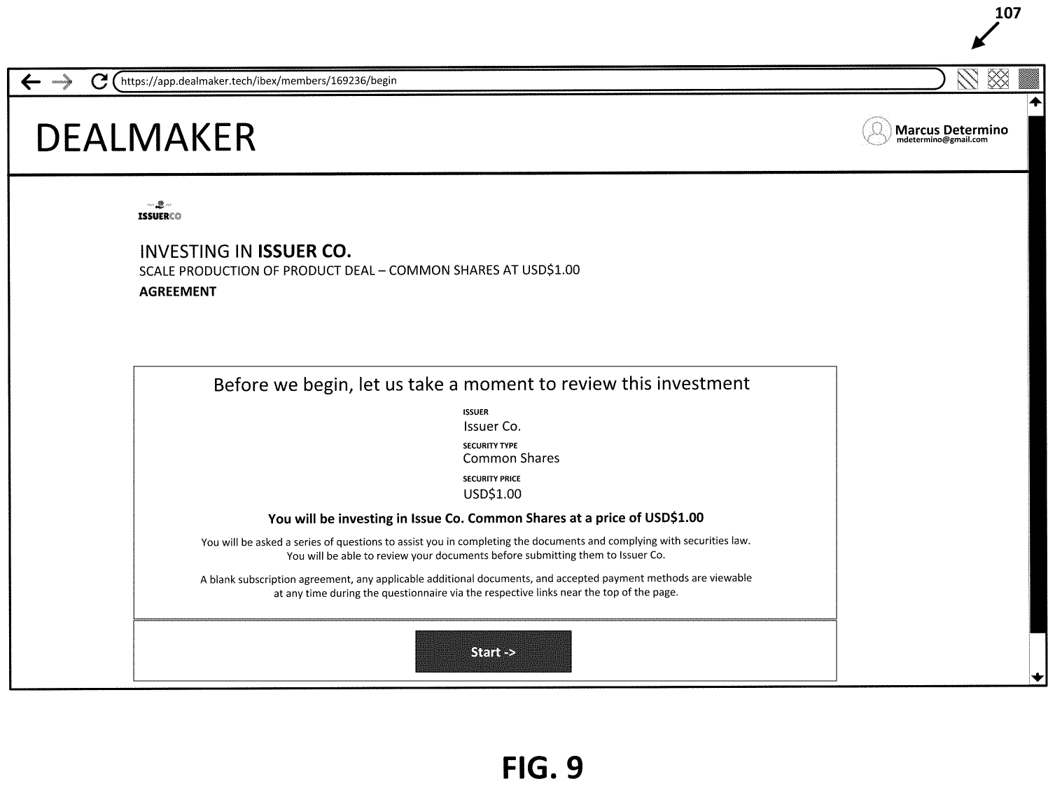

FIG. 9 illustrates user interface 107 showing user interface elements presented to a user of computing device 102 enabling the user to review the deal to which the invitation pertained.

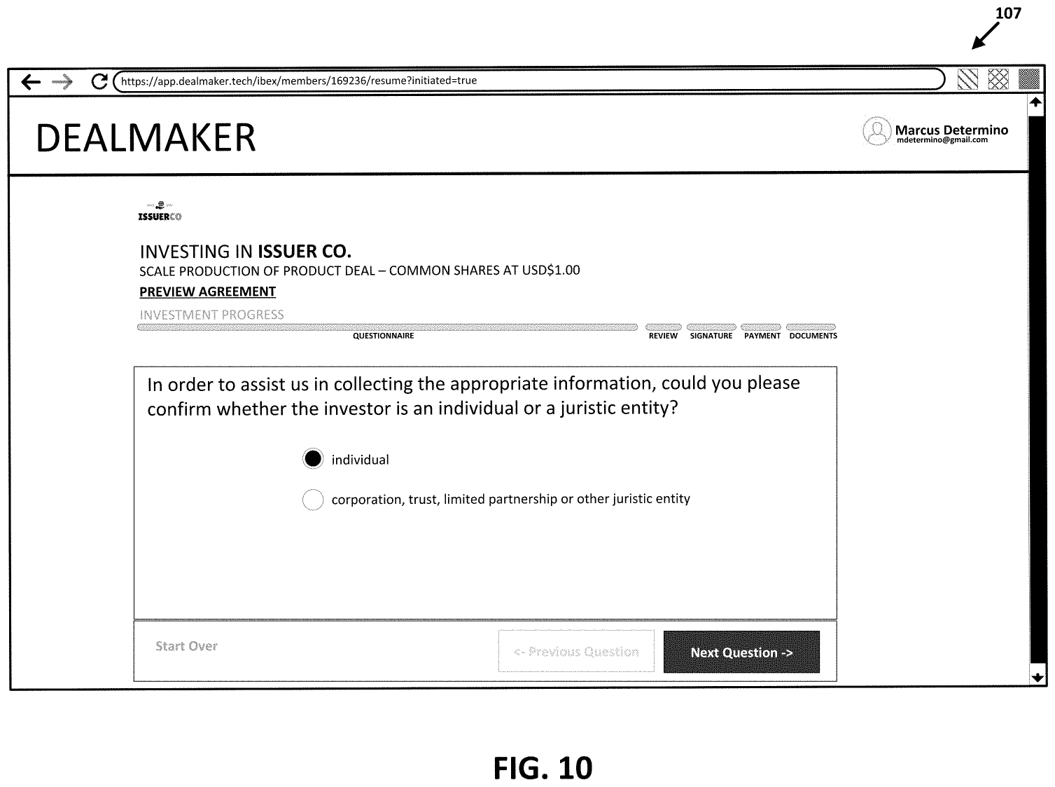

FIG. 10 illustrates user interface 107 showing user interface elements presented to a user of computing device 102 enabling the user to begin completing steps of a questionnaire thereby to enter one or more datapoints about an entity—the user itself or another entity—that may invest in the deal. In this embodiment, individual questions on the questionnaire are divided into respective screens. In this description, dividing individual questions into respective screens provides a technical improvement over a single-screen Web-based questionnaires in which all questions are on a single screen. In particular, because it is possible for a user to become stalled at some point towards completion the questionnaire or executing the subscription/investment agreement or uploading additional documents or making payment, it is preferable for the deal portal to have one or more datapoints on exactly where the user has stalled, such as on exactly which question of a questionnaire. If a user were to be completing a single-screen Web-based questionnaire, the user may stall halfway through the screen on a particular question, such that stopping the process by leaving the screen would carry all of the answers the user had entered to that point with it. With an implementation that provides individual questions on their own screens, the deal portal has as much information as the user is able to provide up until the time of stalling. This may help the deal portal, and cloud-based computing system 116 in general, to determine a propensity score for the entity, as well as to select an appropriate intervention 308, as will be described.

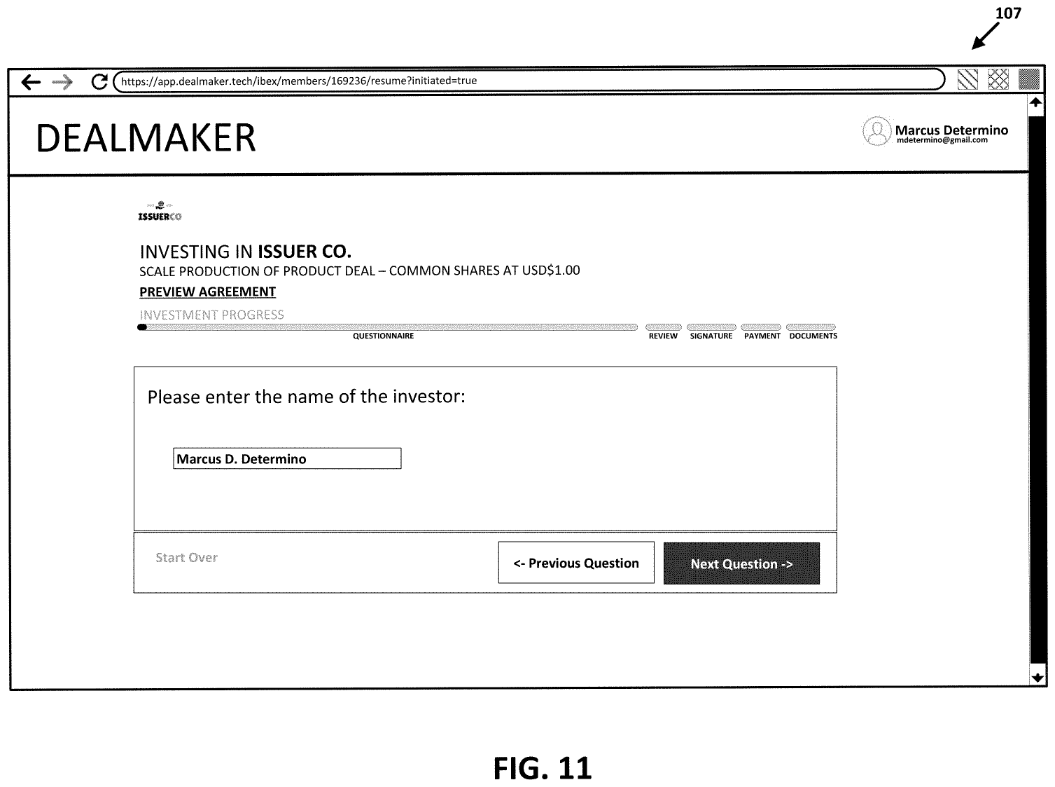

FIG. 11 illustrates user interface 107 showing user interface elements presented to a user of computing device 102 enabling the user to continue through the steps of the questionnaire.

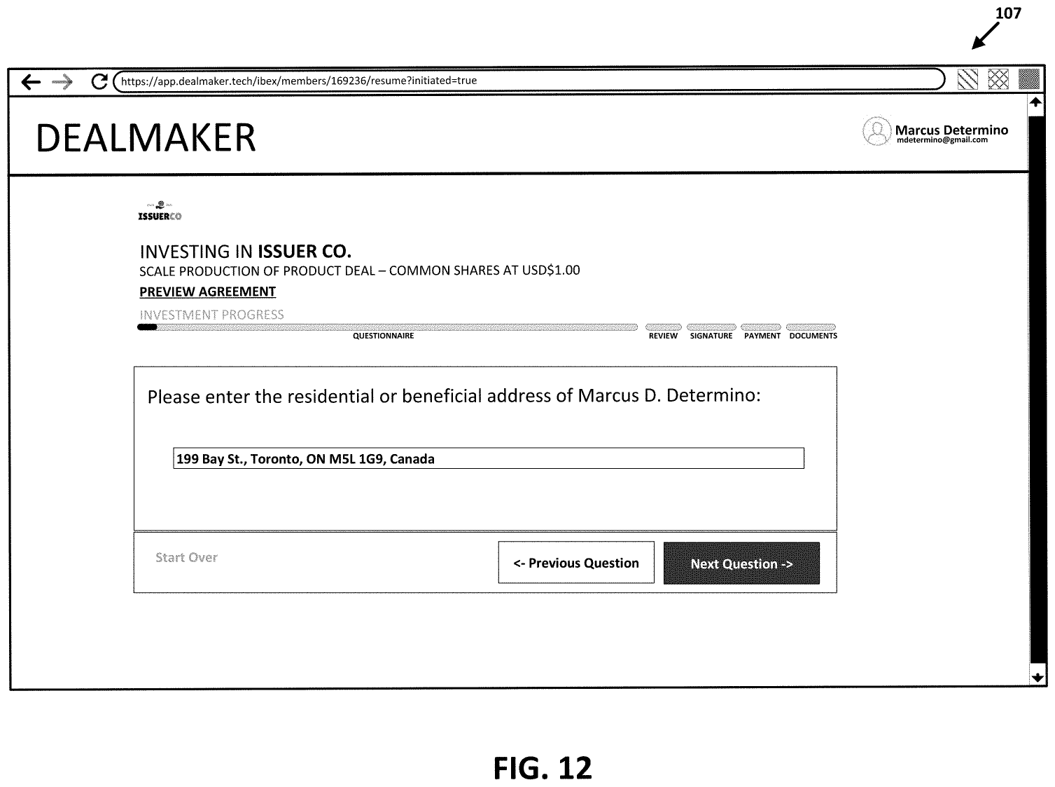

FIG. 12 illustrates user interface 107 showing user interface elements presented to a user of computing device 102 enabling the user to continue through the steps of the questionnaire.

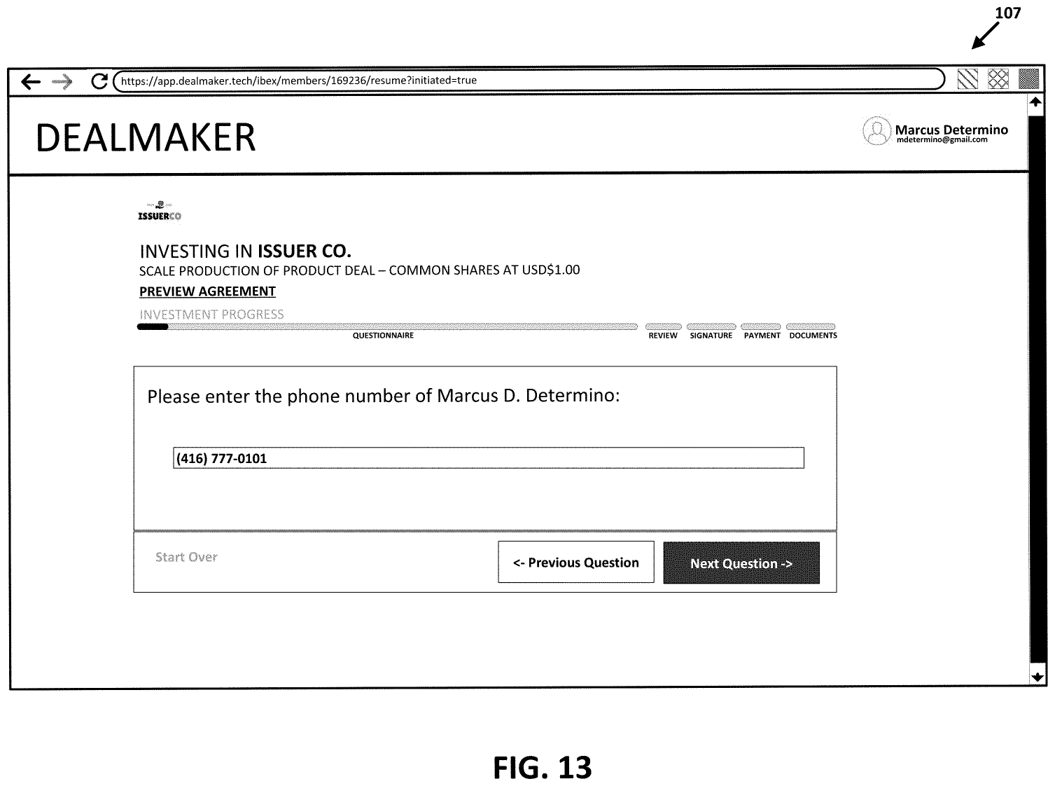

FIG. 13 illustrates user interface 107 showing user interface elements presented to a user of computing device 102 enabling the user to continue through the steps of the questionnaire.

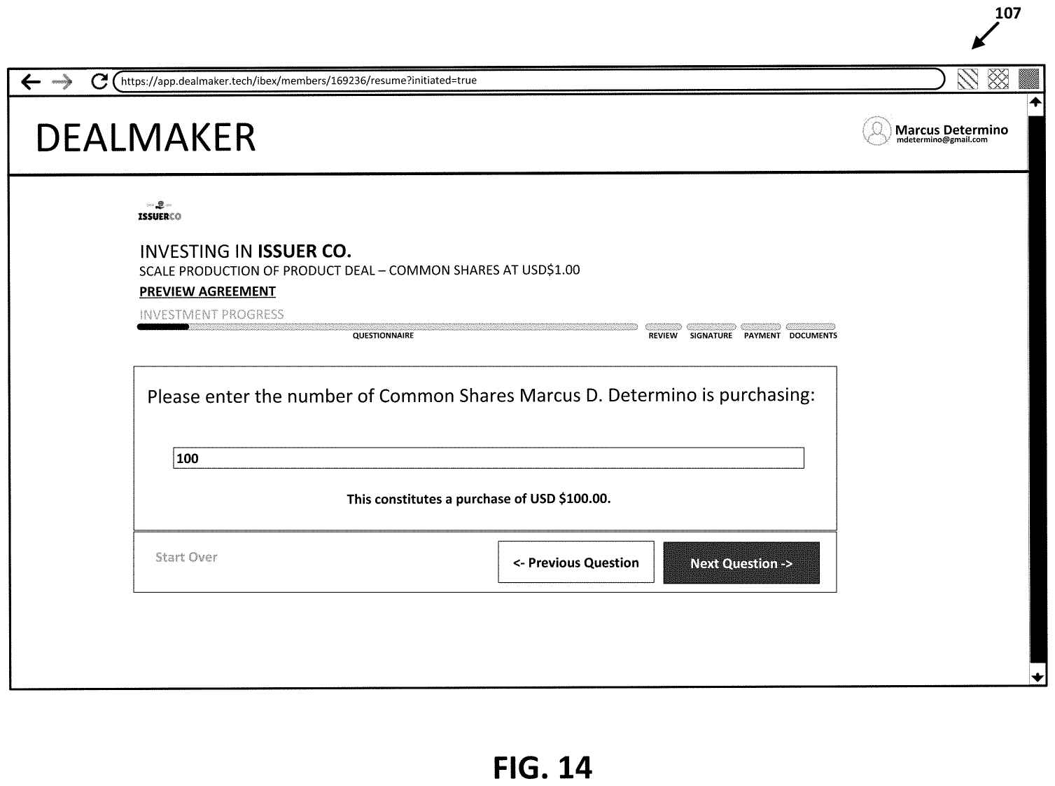

FIG. 14 illustrates user interface 107 showing user interface elements presented to a user of computing device 102 enabling the user to continue through the steps of the questionnaire.

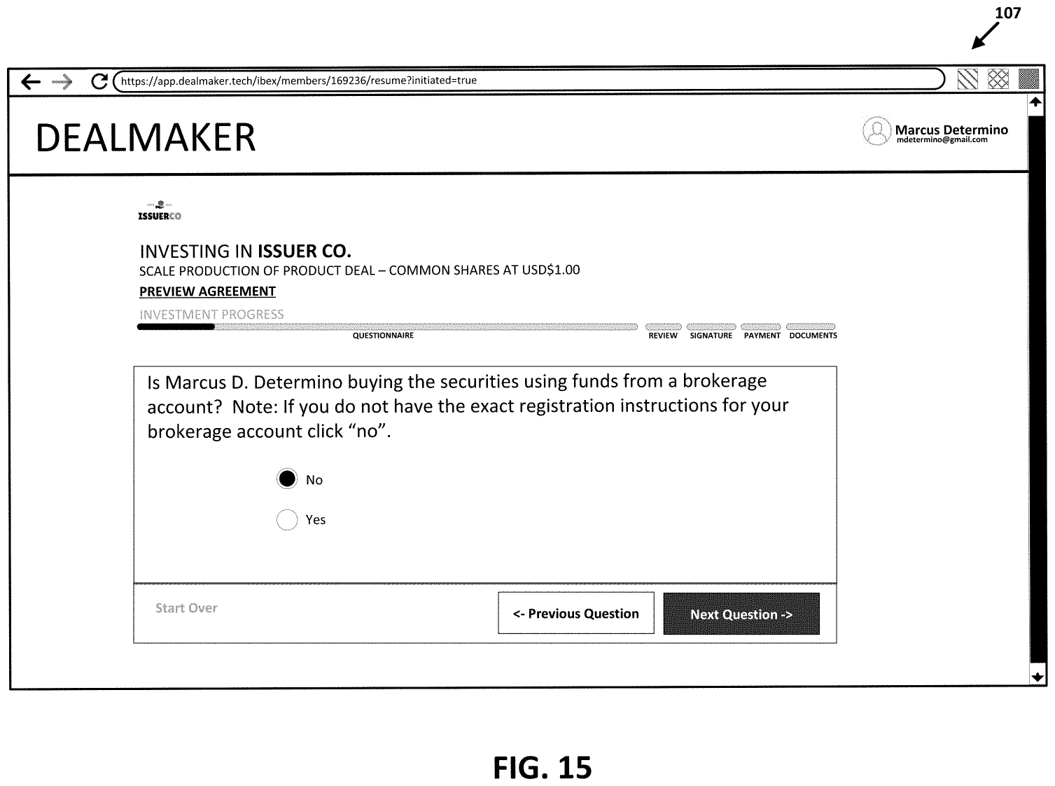

FIG. 15 illustrates user interface 107 showing user interface elements presented to a user of computing device 102 enabling the user to continue through the steps of the questionnaire.

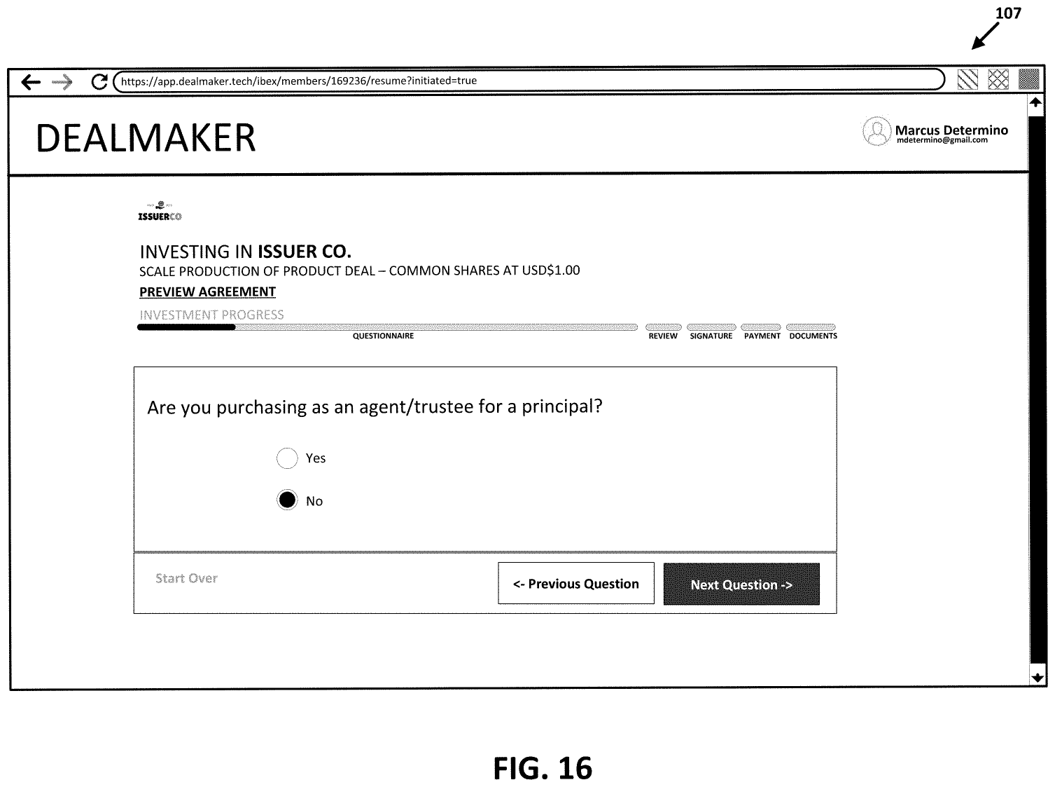

FIG. 16 illustrates user interface 107 showing user interface elements presented to a user of computing device 102 enabling the user to continue through the steps of the questionnaire.

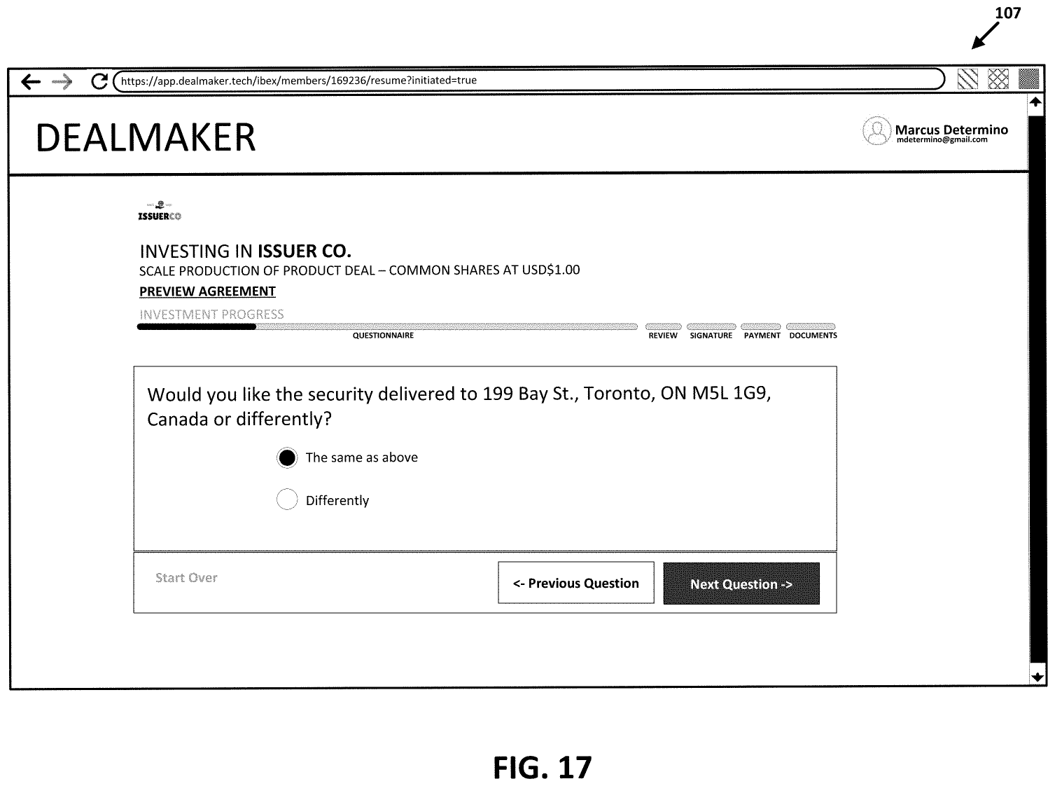

FIG. 17 illustrates user interface 107 showing user interface elements presented to a user of computing device 102 enabling the user to continue through the steps of the questionnaire.

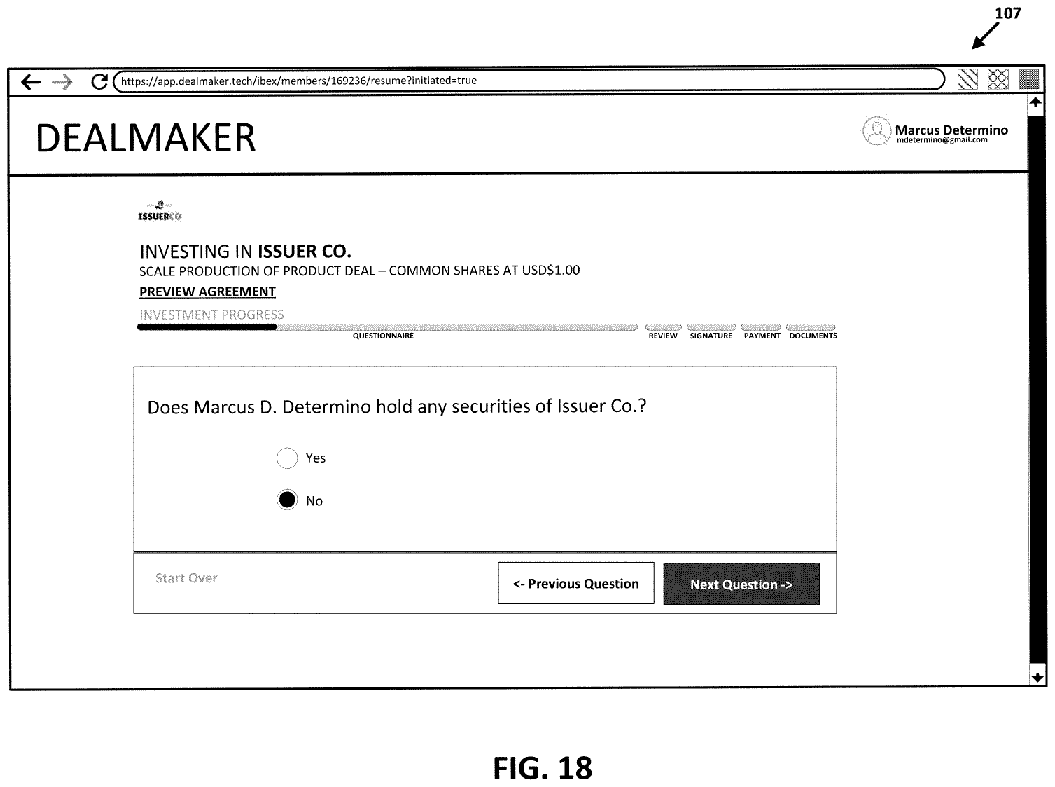

FIG. 18 illustrates user interface 107 showing user interface elements presented to a user of computing device 102 enabling the user to continue through the steps of the questionnaire.

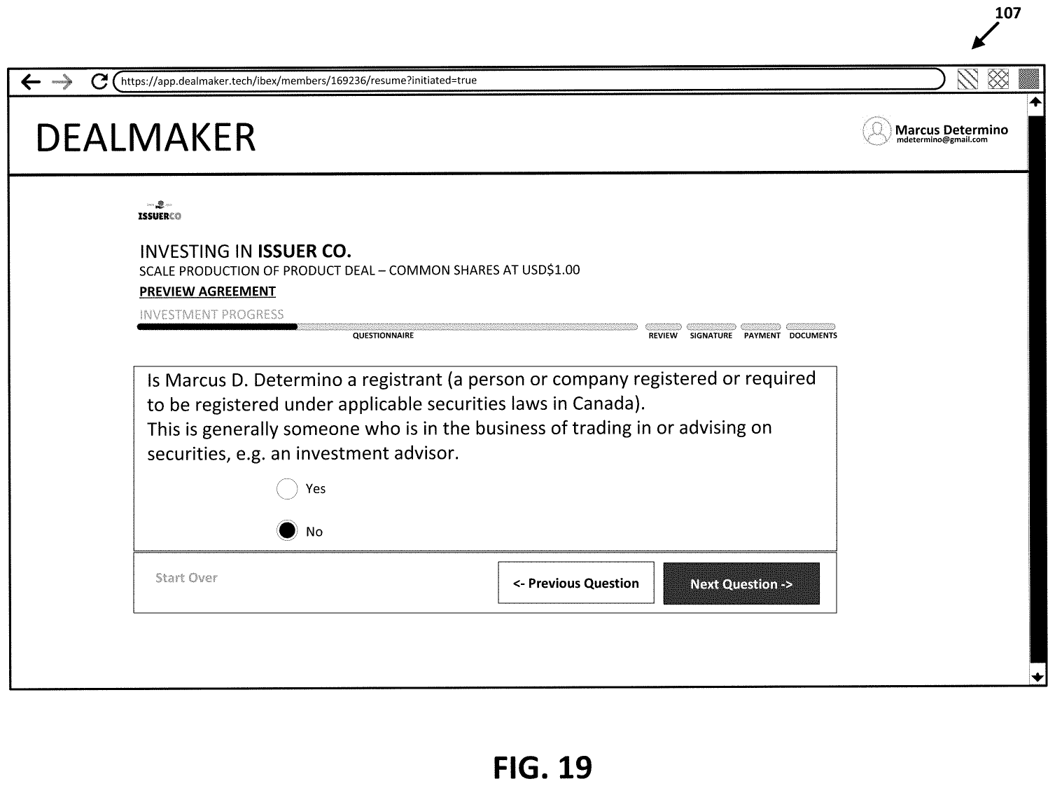

FIG. 19 illustrates user interface 107 showing user interface elements presented to a user of computing device 102 enabling the user to continue through the steps of the questionnaire.

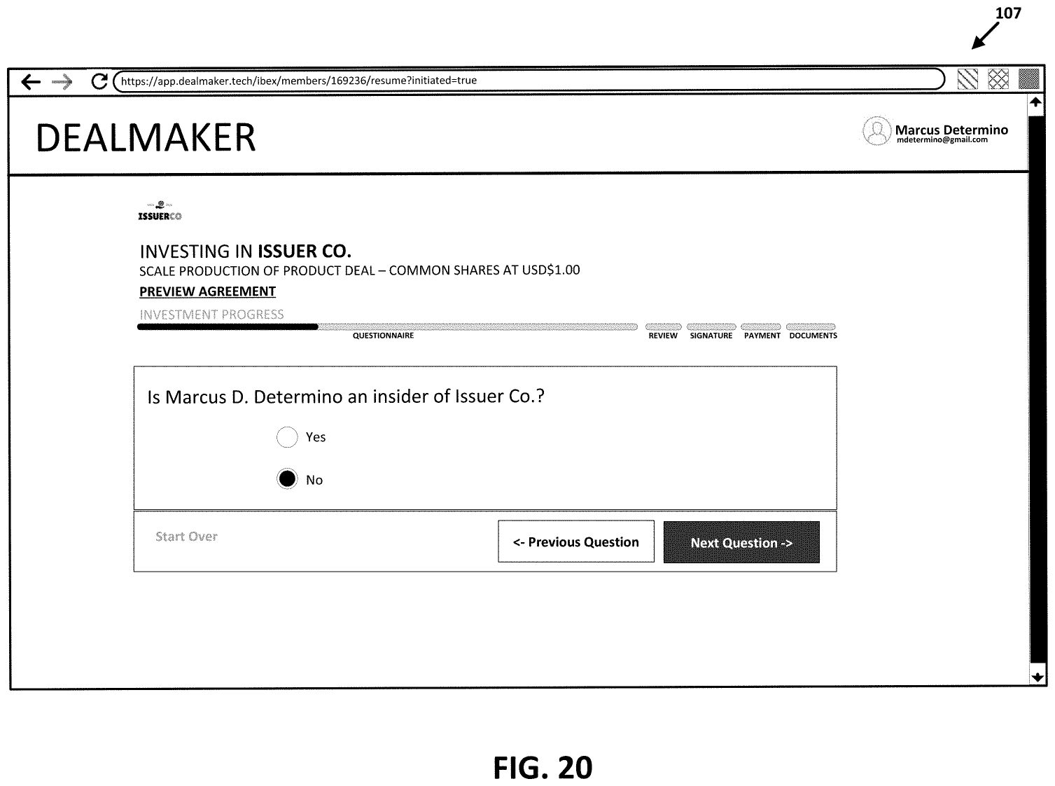

FIG. 20 illustrates user interface 107 showing user interface elements presented to a user of computing device 102 enabling the user to continue through the steps of the questionnaire.

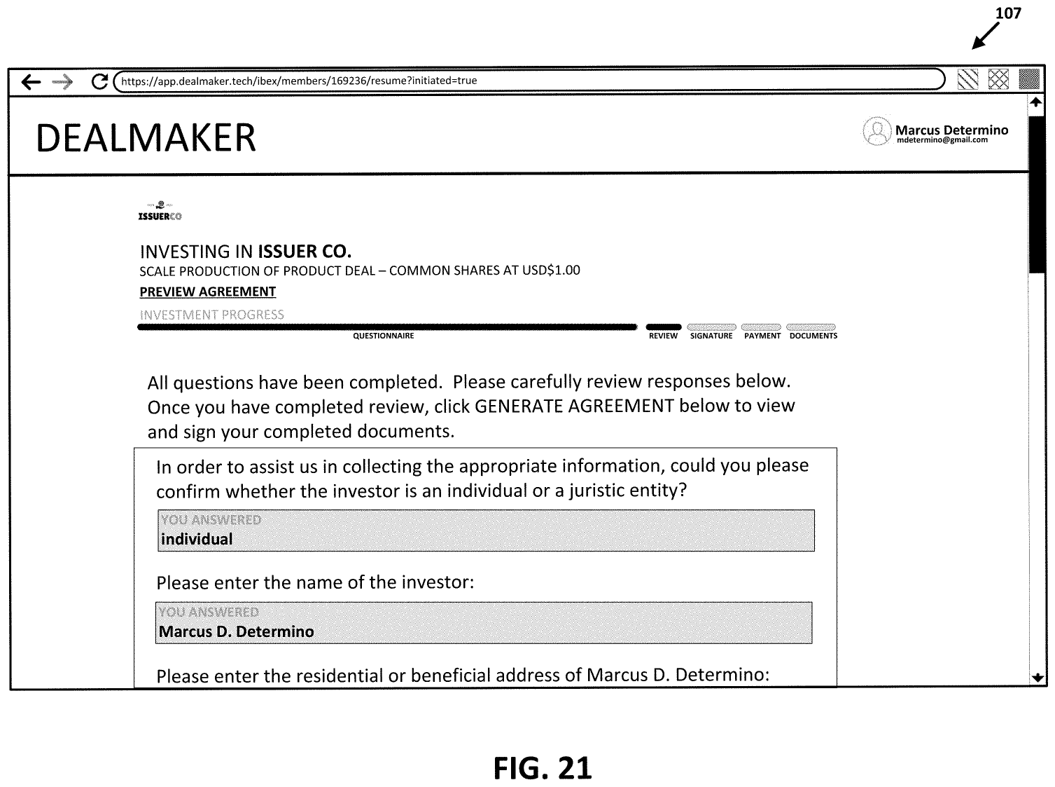

FIG. 21 illustrates user interface 107 showing user interface elements presented to a user of computing device 102 enabling the user to review the one or more datapoints the user entered into the questionnaire.

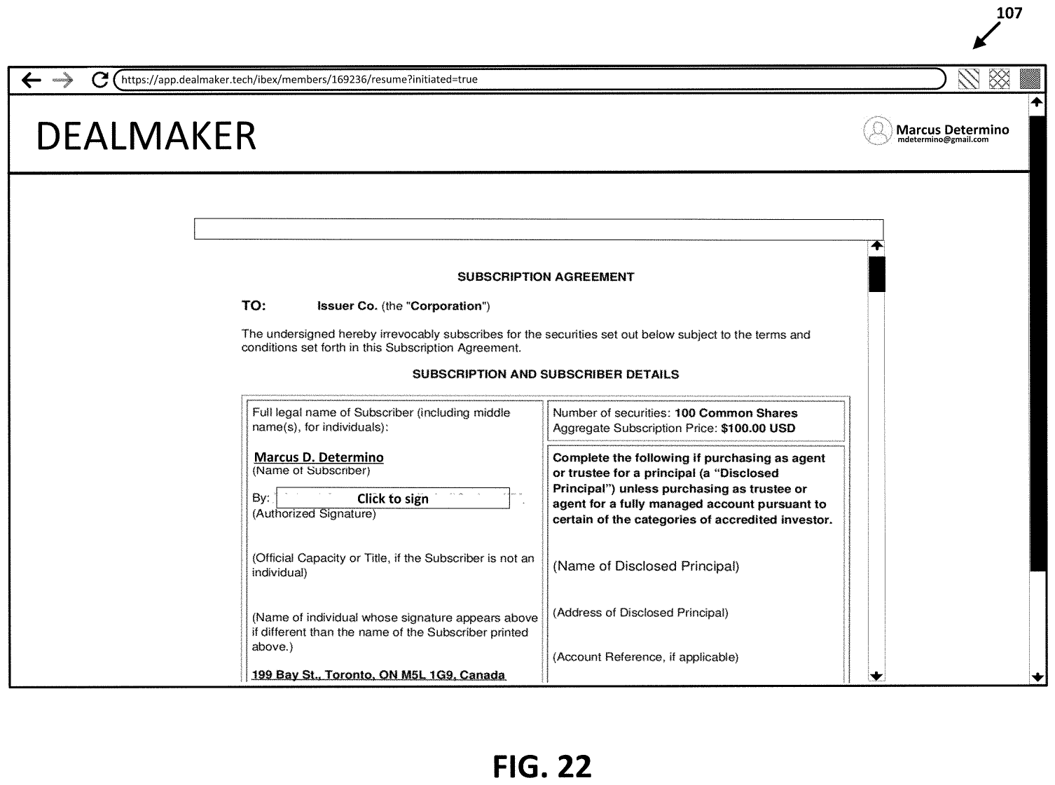

FIG. 22 illustrates user interface 107 showing user interface elements presented to a user of computing device 102 enabling the user to review and begin the processing of digitally executing an investment/subscription agreement automatically generated in accordance with one or more datapoints about the deal and one or more datapoints about the entity.

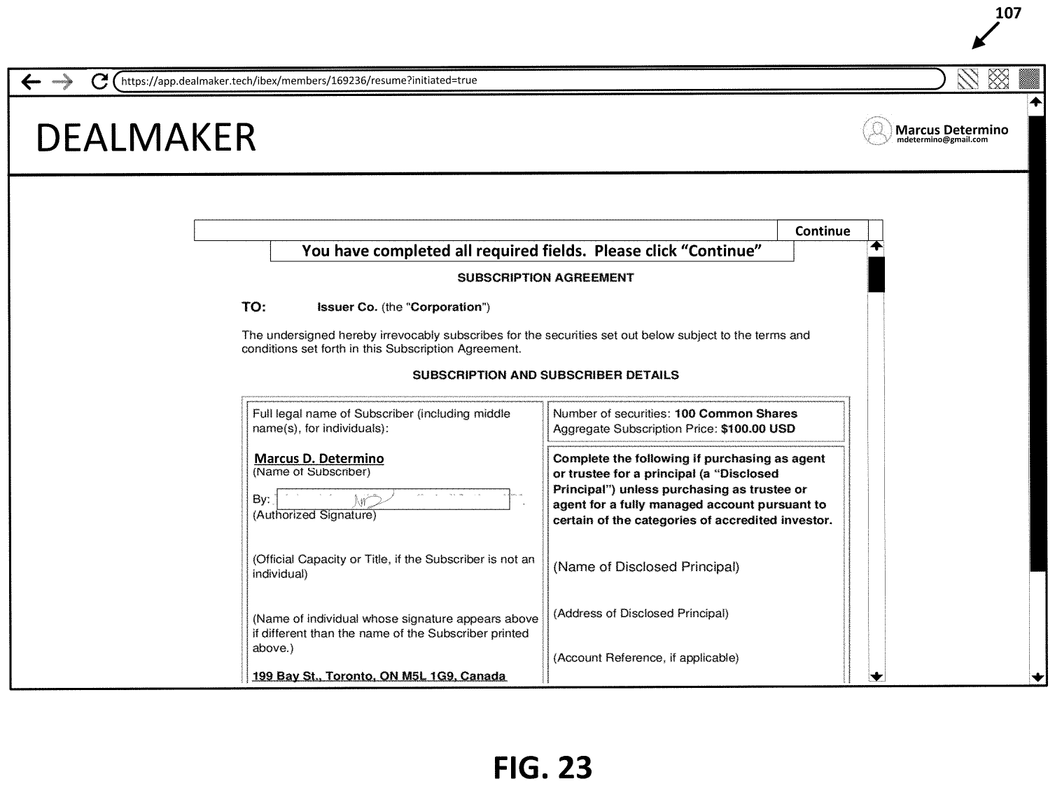

FIG. 23 illustrates user interface 107 showing user interface elements presented to a user of computing device 102 enabling the user to review their digital execution of the investment/subscription agreement.

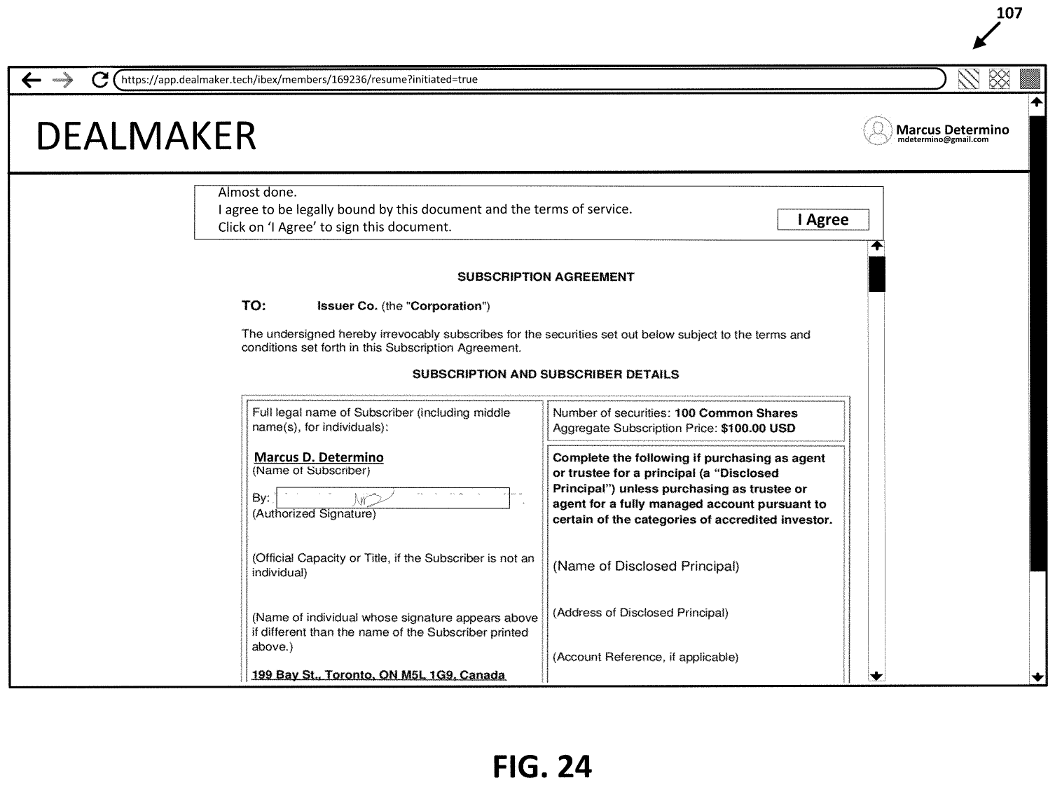

FIG. 24 illustrates user interface 107 showing user interface elements presented to a user of computing device 102 enabling the user to confirm agreement of their digital execution of the investment/subscription agreement.

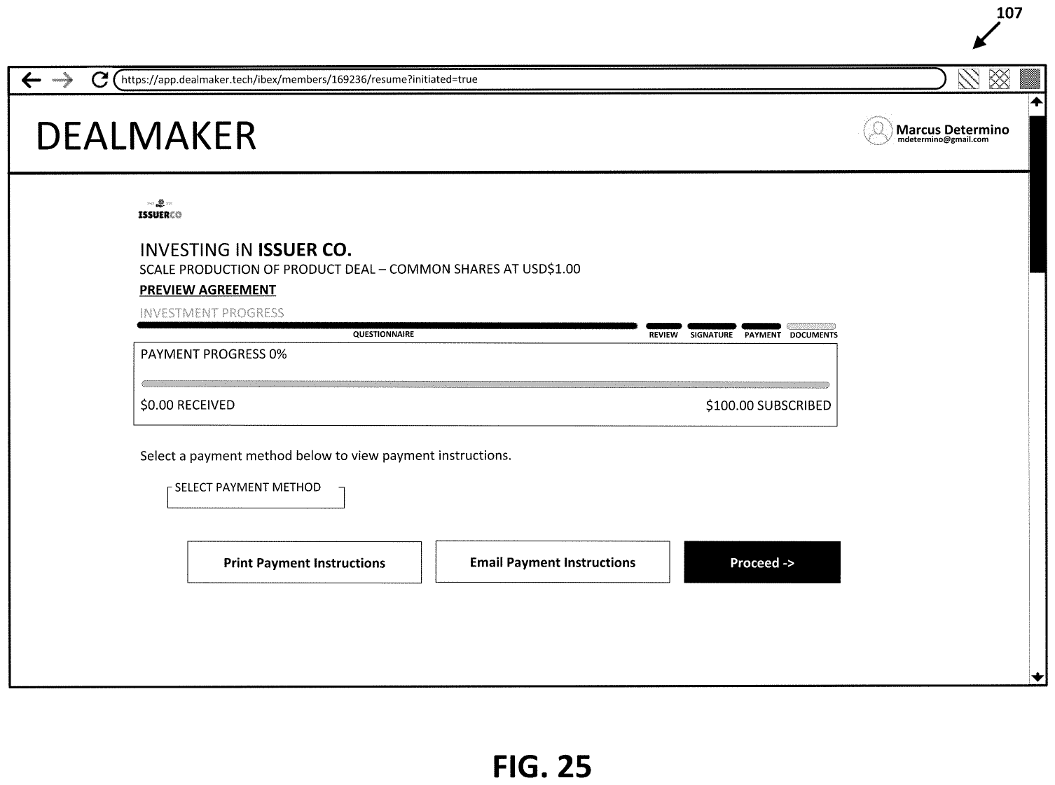

FIG. 25 illustrates user interface 107 showing user interface elements presented to a user of computing device 102 enabling the user to begin the processing of payment in accordance with the executed investment/subscription agreement.

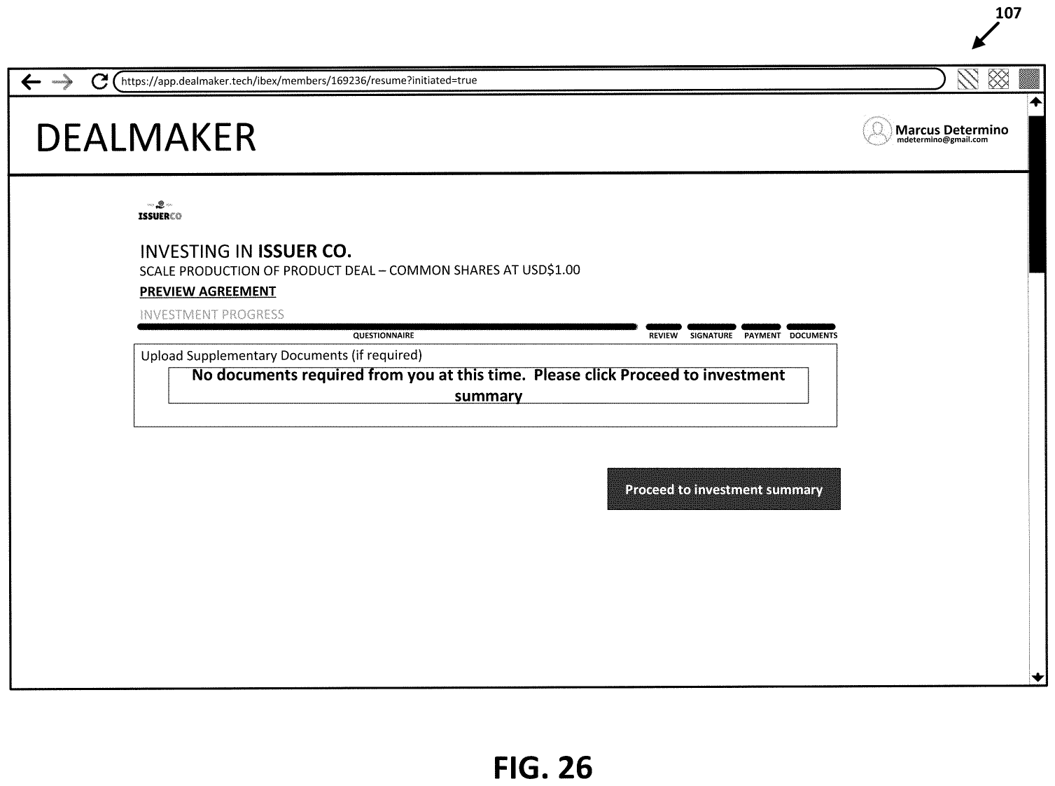

FIG. 26 illustrates user interface 107 showing user interface elements presented to a user of computing device 102 enabling the user to upload additional documents, as required, for provision to the issuer along with the executed investment/subscription agreement.

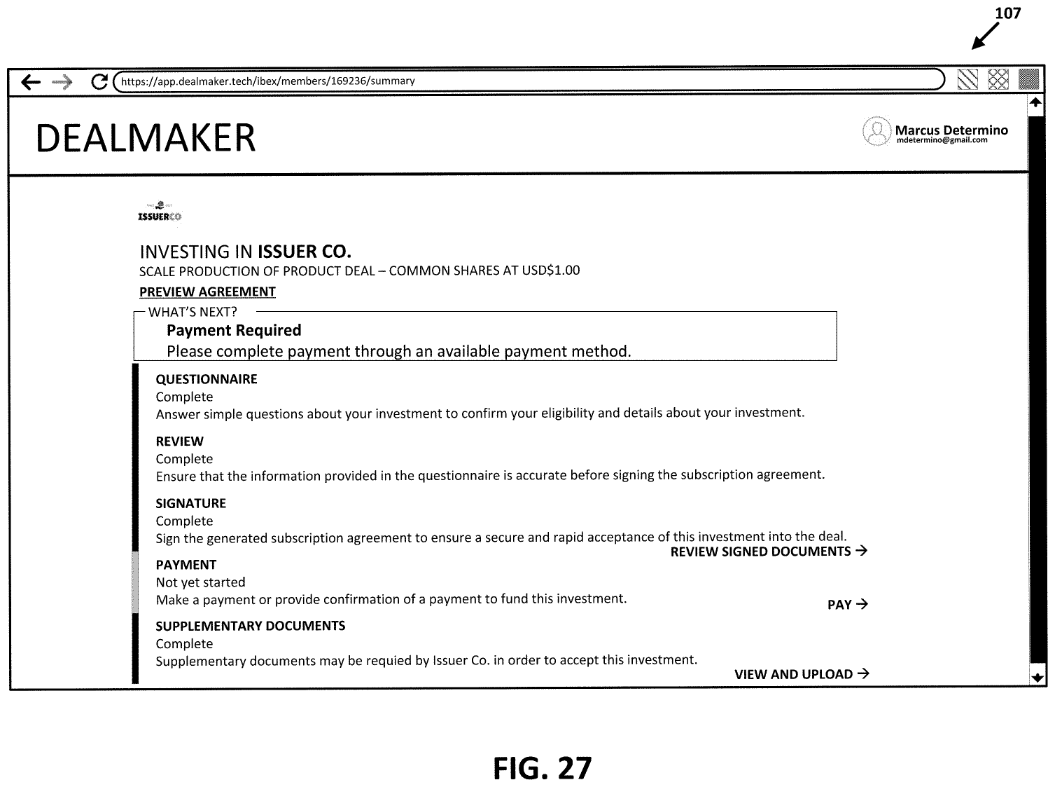

FIG. 27 illustrates user interface 107 showing user interface elements presented to a user of computing device 102 enabling the user to review the investment summary, including status of payments and/or other requirements to complete the investment in the deal.

In some embodiments, cloud-based computing system 116 includes one or more servers 128 that form a distributed, grid, and/or peer-to-peer (P2P) computing architecture. Each of servers 128 may include one or more processing devices, memory devices, data storage, and/or network interface devices. Servers 128 may be in communication with one another via any suitable communication protocol.

Servers 128 may determine the propensity of an entity to invest in a deal based on one or more datapoints about the entity and based on one or more datapoints about the deal. As will be described, servers 128 may use one or more machine learning models 154 trained to determine the propensity of an entity to invest in a deal, to determine when multiple determinations of the propensity of the entity to invest in the deal made at different times differ by threshold amounts, to determine datapoints about the kind of entity that would have a high propensity to invest in a particular deal, and/or to determine whether a given funnel of prospective investors, based on their propensities to invest and the amounts of investments they have indicated they will make, will satisfy the goals of the issuer in issuing a particular deal.

In some embodiments, cloud-based computing system 116 includes a training engine 152 and/or one or more machine learning models 154. Training engine 152 and/or the one or more machine learning models 154 are communicatively coupled to servers 128 or may be included in one of servers 128.

The one or more of machine learning models 154 may refer to model artifacts created by training engine 152 using training data that includes training inputs and corresponding target outputs (correct answers for respective training inputs). Training engine 152 may find patterns in the training data that map the training input to the target output (the answer to be predicted), and provide machine learning models 154 that capture these patterns. The set of machine learning models 154 may comprise, e.g., a single level of linear or non-linear operations (e.g., a support vector machine [SVM]) or a deep network, i.e., a machine learning model comprising multiple levels of non-linear operations. Examples of such deep networks are neural networks including, without limitation, convolutional neural networks, recurrent neural networks with one or more hidden layers, and/or fully connected neural networks.

In some embodiments, the training data may include one or more datapoints about entities, one or more datapoints about deals, feedback (i.e., an indication or linkage) about in which of the deals the entities had completed an investment, and feedback about which of the other deals the entities had not completed an investment. The feedback about in which of the deals the entities had completed an investment may include datapoints detailing the actual agreement the entities had made with the issuer when completing the investment, such as datapoints about the price of the investment, the type of security purchased, the numbers of securities purchased, and other such entity-deal datapoints for the investment in a deal that was actually completed. The feedback about which of the other deals the entities had not completed an investment may include datapoints detailing how far towards finalizing the agreement the entities had proceeded before ultimately deciding not to complete their investment.

The input data for training may be obtained from deal and entity datapoints pertaining to issuers and entities that had used the deal portal to issue and invest in deals in the past. However, the training data may alternatively or in some combination be obtained from other sources, such as a third party database 130.

Machine learning models 154 may be trained to use processing using if-then rules, and/or statistical models. Statistical models may make soft, probabilistic decisions based on attaching real-valued weights to each input feature. Such models may have the advantage that they may express relative certainty of many different possible answers rather than just one, thereby producing results that are more reliable when such a model is included as a component of a larger system. The learning procedures used during machine learning processing may automatically focus on the most common cases. Further, automatic learning procedures may make use of statistical-inference algorithms to produce models that are robust to unfamiliar input (e.g. containing words or structures that have not been seen before) and to erroneous input (e.g. with misspelled words or words accidentally omitted). Further, systems based on automatically learning of the rules can be made more accurate simply by supplying more input data.

Machine learning models 154 may be trained on a regular basis, such as every month or quarter. It will be appreciated that retraining machine learning models 154 may allow for the consumption of new input variables or to remove old input variables that are learned to be no longer relevant. It will be appreciated that, in a linear regression kind of model, a predicted output y may be modeled as in Equation (1), below:

Y=B₀+B₁x₁+B₂x₂+ . . . +Bₙxₙ (1)

where:

x₁ . . . xₙ are input values and B₀ . . . Bₙ are coefficients.

It will be appreciated that the purpose of training a linear regression machine learning model is to ascertain the coefficients B₀ . . . Bₙ from training data. With the coefficients thereby having been ascertained, a predicted output could be determined from a new set of input values. It will be appreciated that other kinds of models will have different structures and thus different goals for their training than necessarily the determination of coefficients. In particular, a linear regression model is but one kind of model that could be trained and deployed in the present application to receive datapoints about an entity and/or datapoints about a deal and produce an output.

Cloud-based computing system 116 could receive datapoints about an entity and datapoints about a deal and produce a propensity score representing the propensity of the entity to invest in the deal. The propensity score itself could be sold as a tangible asset to, for example, the issuer of the deal to which it pertains. The issuer, who would not normally be the owner of the deal portal itself nor the party engaging in training of the machine learning models 154 using datapoints about past deals, datapoints about past entities, and the feedback as described above, may consider the propensity score to be of great value. This is because, for example, a sufficiently accurate propensity score could enable the issuer to confidently shift resources and attention towards those entities with the highest propensity scores on a particular deal. In a deal with thousands of entities as potential investors in a funnel, a determination of those entities having the highest propensity score would enable the issuer to differentially value—as investors—the entities. This would enable the issuer to focus resources and attention that would otherwise have been spread much more evenly across all entities invited to and/or who have merely engaged a deal. Spreading of resources and attention evenly across all entities may result in no entity receiving sufficient attention by the issuer to complete their investment. By enabling an issuer to forego applying resources and attention to the lowest propensity entities in a particular marketing funnel, application of those resources may be increased for the medium and highest propensity entities thus providing such medium and high propensity entities with sufficient attention to complete their investment in the deal.

It will be appreciated that certain single issuers may not necessarily have access to sufficient amounts of their own data about their own deals and their own investors on past deals to sufficiently train any machine learning models 154 such that they provide worthwhile predictions about propensities of new entities to invest on new deals. As such, system architecture 100 may be configured to serve as a platform for many different issuers issuing many different deals at many different times. Such a platform may receive data about actual deals, actual issuers, actual investments and actual declinations to invest by many different actual entities, and may as a result capture sufficient amounts of training input data to provide sufficiently accurate predictions that may be made available to new and existing issuers about the propensities entities may have to invest in their deals.

In addition to a given propensity score itself being sellable as a tangible asset, derivative products such as reports containing multiple entities' propensity scores enable relative propensity scores to be judged, and/or reports containing data regarding changes to entities' propensity scores over time, and/or reports containing profiles of the features of entities that could be predicted to have highest propensity scores for a particular kind of deal, and/or reports containing data regarding whether a given marketing funnel is predicted to contain all the investors a particular deal will need (predicting that more marketing to add to the funnel may not need spending on) can each be sold as tangible assets. Such propensity scores and/or such derivative tangible assets may be sold as value-added options to, for example, an issuer who has established a new deal profile on the deal portal. The issuer may pay a premium for the propensity scores and/or such derivative tangible assets. The value to the issuer may lie in the additional insights into their own deals' current and trending prospects as it progresses towards completion, to by differentially valuing entities as investors inform actions that the issuer could take to aid or prompt entities—as a cohort or as individuals—to complete their respective investments.

Both training input data for training machine learning models 154, and input data at the time of determining a propensity of an entity to invest in a deal or otherwise to use the trained machine learning models 154 may be cleaned by removing noise, removing collinearity, inputting missing values, and the like, as would be understood.

In some embodiments, the trained machine learning model 154 may receive input datapoints about the user (e.g., entered by the user using the user interface 107, extracted by the user interface 107 from a database of another application via an API, or obtained in other ways), and input datapoints about a deal, and produce a propensity score representing the propensity of the entity to invest in the deal.

In some embodiments, the machine learning models 60 are linked such that their outputs are used as inputs to one another. For example, a propensity score output by a first machine learning model 154 may be input into a second machine learning model 154 that outputs a severity of a change in propensity score for the entity in respect of a deal.

In some embodiments, the cloud-based computing system 116 may include a database 129. The third party database 130 may store data pertaining to observations determined by the machine learning models 154. The observations may pertain to the propensity score of entities with respect to deals and/or changes in propensity score over time of entities with respect to deals. The observations may be stored by the database 129 over time to track the decreases and/or increases of the propensity score of the entity with respect to a deal. Further, the observations may include indications of which types of interventions are successful in improving the propensity score when an entity has a particular propensity score. In some embodiments, the actual datapoints received from the computing device 102 may not be stored by the database 129. The database 130 may store data pertaining to a corpus of datapoints about entities and datapoints about deals based on the observations. The training data used to train the machine learning models 154 may be stored in the database 129.

In some embodiments, the cloud-based computing system 116 may include an application programming interface (API) 135 that communicatively couples to the third party database 130 via the network 112. The API 135 may be implemented as computer instructions stored on one of the servers 128 and executed by a processing device of one of the servers 128. The third party database 130 may store data pertaining to datapoints about entities and datapoints deals and correlated propensity scores of entities. In some embodiments, the third party database 130 may not store the actual datapoints about the entities or about the deals. The data in the third party database 130 may be harvested from computing devices of users of the entity using tracking applications and/or survey applications. The API 135 may extract the data from the third party database 130 to perform the techniques disclosed herein. The training data used to train the machine learning models 154 may be stored in the third party database 130. The stored data may be encrypted.

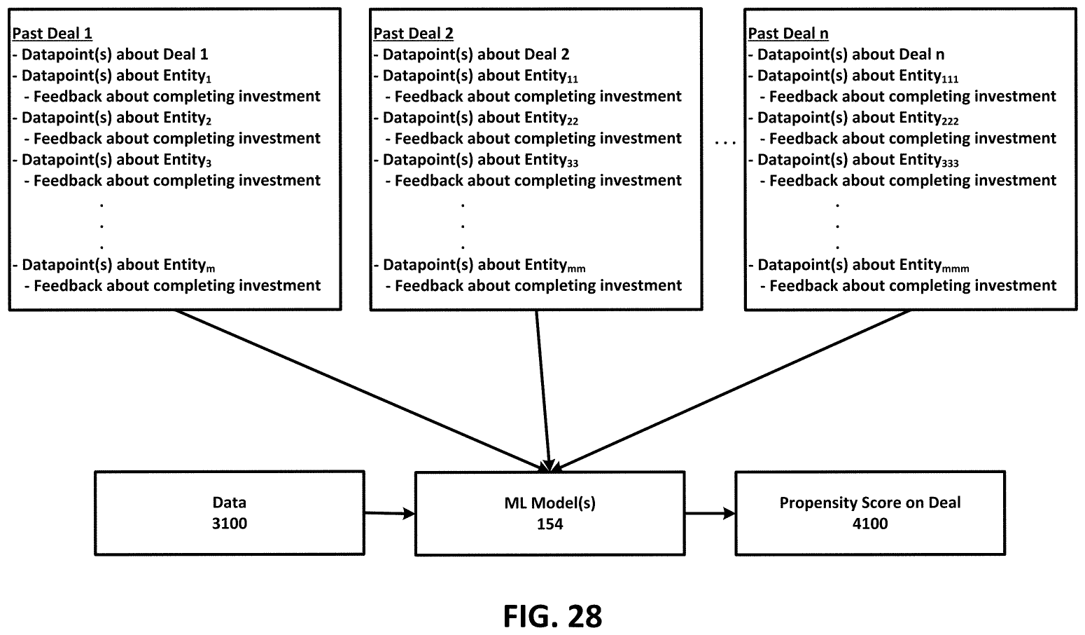

FIG. 28 is an example block diagram of training machine learning model(s) 154 to output, based on data 3100 pertaining to one or more datapoints about a deal and one or more datapoints about an entity, a propensity score 4100 representing the propensity of the entity to invest in the deal. One or more datapoints pertaining to each of a plurality of other deals, and one or more datapoints pertaining to each of a plurality of other entities associated with the other deals, and feedback about in which of the other deals the plurality of entities had completed an investment, and feedback about in which of the other deals the other entities had not completed an investment, may be received by server(s) 128. The one or more datapoints about other deals and the one or more datapoints about the other respective entities and about the feedback may be included in an input training dataset used to train machine learning model(s) 154. For example, machine learning model(s) 154 may be trained using this input data to identify similarities of the one or more datapoints about a new entity with other datapoints about other entities, and to identify similarities of the one or more datapoints about a new deal with other datapoints about other deals, and to produce a propensity score 4100 representing a prediction as to the propensity of the new entity to invest in the new deal. A propensity score 4100 may take the form of a number, or letter, or some other form that is understood to indicate a level relative to a baseline value or a level relative to values of other propensity scores 4100. Such a propensity score 4100 may thereafter be sold as a tangible asset, may be combined with other data such as a propensity score of another entity to be sold together as a derivative tangible asset, and/or may be used during a subsequent process, such as input data to another of machine learning model(s) 154.

A propensity score 4100 for an entity may be useful for enabling a user, such as the issuer of the deal, to differentially value the entity in terms of the entity's propensity to invest in the deal as compared with other entities. As such, a propensity score 4100 for an entity in respect of a deal may be useful to an issuer when it is provided with at least one other propensity score 4100 of another entity in respect of the deal. Predicting differential value of entities as investors on a deal may inform an issuer how best to differentially distribute their own deal resources (time, attention, money) amongst entities, to be effective. For example, an issuer may choose to forego deploying deal resources to medium to low propensity entities on the deal who would not likely respond in the issuer's favour to the resources, and to shift to deploying the deal resources towards medium to high propensity entities on the deal who may respond in the issuer's favour to the resources, without necessarily changing the overall amount of deal resources deployed. In this way, propensity scores 4100 may be valuable for informing how given deal resources may be differentially deployed amongst entities to be effective.

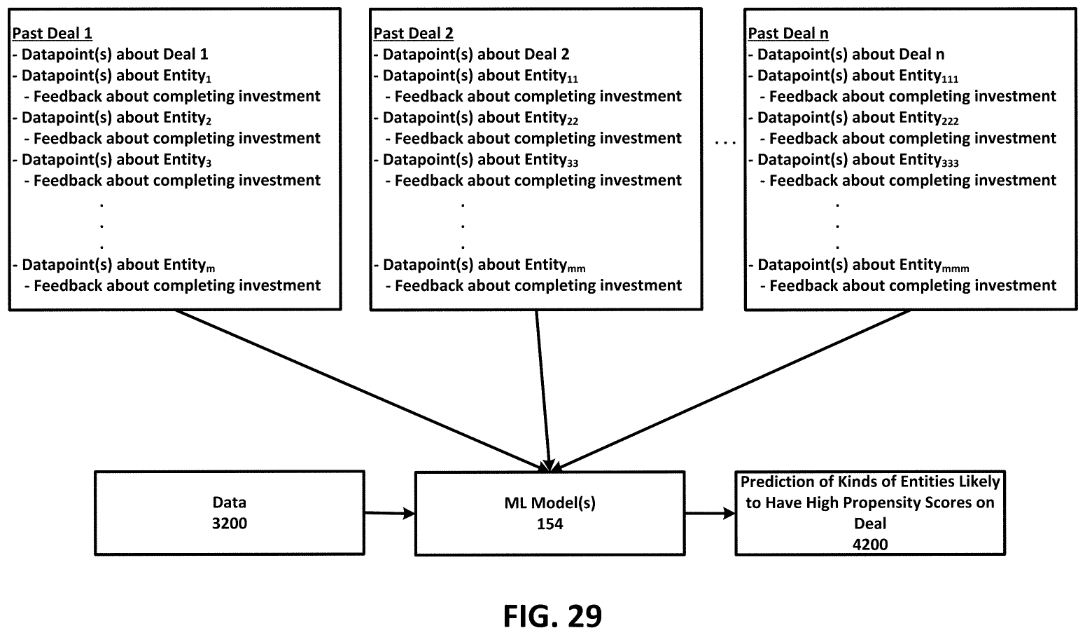

FIG. 29 is an example block diagram of training machine learning model(s) 154 to output, based on data 3200 pertaining to one or more datapoints about a deal, a prediction 4200 of kinds of entities likely to have high propensities to invest in the deal. One or more datapoints pertaining to each of a plurality of other deals, and one or more datapoints pertaining to each of a plurality of other entities associated with the other deals, and feedback about in which of the other deals the plurality of entities had completed an investment, and feedback about in which of the other deals the other entities had not completed an investment, may be received by server(s) 128. The one or more datapoints about other deals and the one or more datapoints about the other respective entities and about the feedback may be included in an input training dataset used to train machine learning model(s) 154. For example, machine learning model(s) 154 may be trained using this input data to identify similarities of the one or more datapoints about a new deal with other datapoints about other deals, and to produce a prediction 4200 about one or more datapoints about kinds of entities that are likely to have high propensity scores on the new deal. In some embodiments, a prediction 4200 may be generated in the form of a computer-displayable report containing one or entity profiles each including one or more datapoints about a kind of entity. For example, a prediction 4200 may include a profile with set of attributes about a notional entity that is predicted to have a highest propensity to invest in the new deal, such as (for example) any entity that is an individual who lives in a particular Canadian province, has an age within a particular range, and is female. Such a prediction 4200 may also include another profile with a set of attributes about a notional entity that is predicted to have next to highest propensity to invest in the new deal, such as (for example), any entity that is an individual who lives in a particular Canadian provide, has an age within a particular different range, and is male.

Such a prediction 4200 may thereafter be sold as a tangible asset, may be combined with other data to be sold together as a derivative tangible asset, and/or may be used during a subsequent process, such as input data to another of machine learning model(s) 154.

A prediction 4200 may be useful for enabling a user, such as the issuer of a deal, to differentially value kinds of entities in terms of the kinds of entities' propensities to invest in the deal as compared with other kinds of entities, primarily at the point of planning initial and ongoing deal structuring and marketing. Predicting differential value of kinds of entities as investors on a deal may inform an issuer how best to differentially distribute their own marketing resources (like deal resources: time, attention, money) amongst kinds of entities, to be effective. For example, an issuer may choose to forego deploying marketing resources to medium to low propensity kinds of entities on the deal who would not likely respond in the issuer's favour to the resources, and to shift to deploying the marketing resources towards medium to high propensity kinds of entities on the deal who may respond in the issuer's favour to the resources, without necessarily changing the overall amount of marketing resources deployed. In this way, prediction 4200 may be valuable for informing how given marketing resources may be differentially deployed amongst entities to be effective. As an example, prediction 4200 may indicate that the kinds of entities predicted to have the highest propensities to invest in the deal do not correlate with the kinds of entities known to use social media. Prediction 4200 may therefore result in an issuer limiting its investment in social media marketing and increasing the investment in print advertising. As another example—indicating the granularity of with which prediction 4200 can be directed—a prediction 4200 may indicate that the kinds of entities predicted to have the highest propensities to invest in the deal correlate with the kinds of entities known generally to use one form of social media (such as Facebook) but do not correlate with the kinds of entities known generally to use another form of social media (such as LinkedIn). Prediction 4200 may therefore result in an issuer limiting its deployment of marketing resources through channels associated with the one form of social media and relatively increasing its deployment of marketing resources through channels associated with the other form of social media.

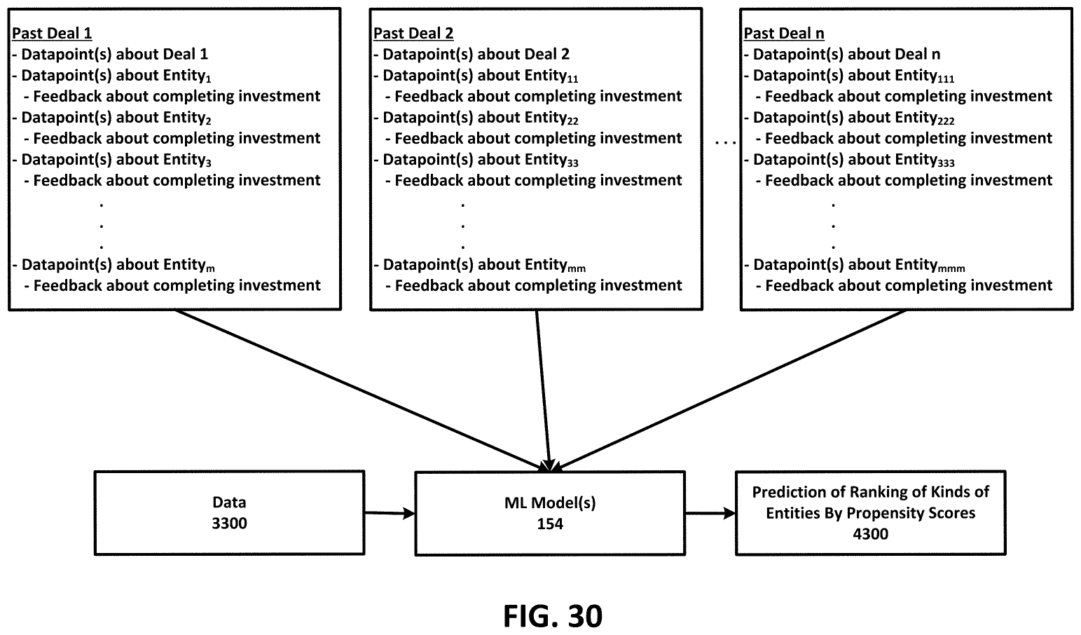

FIG. 30 is an example block diagram of training machine learning model(s) 154 to output, based on data 3300 pertaining to one or more datapoints about each of multiple different kinds of entities and one or more datapoints about a deal, a prediction 4300 of a ranking of the propensities of the different kinds of entities to invest in the deal. One or more datapoints pertaining to each of a plurality of other deals, and one or more datapoints pertaining to each of a plurality of other entities associated with the other deals, and feedback about in which of the other deals the plurality of entities had completed an investment, and feedback about in which of the other deals the other entities had not completed an investment, may be received by server(s) 128. The one or more datapoints about other deals and the one or more datapoints about the other respective entities and about the feedback may be included in an input training dataset used to train machine learning model(s) 154. For example, machine learning model(s) 154 may be trained using this input data to identify similarities of the one or more datapoints about multiple different kinds entities with other datapoints about other entities, and to identify similarities of the one or more datapoints about a new deal with other datapoints about other deals, and to produce a prediction 4300 about which of the multiple different kinds of entities are likely to have high propensity scores on the new deal.

It will be appreciated that this process is similar to that shown in FIG. 29. However, in this embodiment, the proposed multiple different kinds of entities are used as part of data 3300 such that machine learning model(s) 154 ranks the multiple different kinds of entities by propensity, whereas in FIG. 29, the machine learning model(s) construct a kind(s) of entity profile using of one or more datapoints about the entity, predicted to constitute an entity have a higher propensity scores. It will be appreciated that it may be useful to provide pre-constructed entity profiles in an embodiment in which data about marketing information for such kinds of entities are already available. For example, if a body of marketing research provides that particular kinds of entities are best differentially marketed-to using respective different marketing channels, then it may be useful to rank such same kinds of entity using machine learning model(s) 154 in terms of propensity score, so as to by implication inform an issuer as to which marketing channels are predicted to be more effective and less for the deal in question on the basis of the differential attention that entities may pay to different marketing channels.

In some embodiments, a prediction 4300 may be generated in the form of a computer-displayable report containing one or entity profiles each including one or more datapoints about a kind of entity. For example, a prediction 4300 may include a profile with set of attributes about a notional entity that is predicted to have a highest propensity to invest in the new deal, such as (for example) any entity that is an individual who lives in a particular Canadian province, has an age within a particular range, and is female. Such a prediction 4300 may also include another profile with a set of attributes about a notional entity that is predicted to have next to highest propensity to invest in the new deal, such as (for example), any entity that is an individual who lives in a particular Canadian provide, has an age within a particular different range, and is male.

Such a prediction 4300 may thereafter be sold as a tangible asset, may be combined with other data to be sold together as a derivative tangible asset, and/or may be used during a subsequent process, such as input data to another of machine learning model(s) 154.

A prediction 4300 may be useful for enabling a user, such as the issuer of a deal, to differentially value kinds of entities in terms of the kinds of entities' propensities to invest in the deal as compared with other kinds of entities, primarily at the point of planning initial and ongoing deal structuring and marketing. Predicting differential value of kinds of entities as investors on a deal may inform an issuer how best to differentially distribute their own marketing resources (like deal resources: time, attention, money) amongst kinds of entities, to be effective. For example, an issuer may choose to forego deploying marketing resources to medium to low propensity kinds of entities on the deal who would not likely respond in the issuer's favour to the resources, and to shift to deploying the marketing resources towards medium to high propensity kinds of entities on the deal who may respond in the issuer's favour to the resources, without necessarily changing the overall amount of marketing resources deployed. In this way, prediction 4300 may be valuable for informing how given marketing resources may be differentially deployed amongst entities to be effective. As an example, prediction 4300 may indicate that the kinds of entities predicted to have the highest propensities to invest in the deal do not correlate with the kinds of entities known to use social media. Prediction 4300 may therefore result in an issuer limiting its investment in social media marketing and increasing the investment in print advertising. As another example—indicating the granularity of with which prediction 4300 can be directed—a prediction 4300 may indicate that the kinds of entities predicted to have the highest propensities to invest in the deal correlate with the kinds of entities known generally to use one form of social media (such as Facebook) but do not correlate with the kinds of entities known generally to use another form of social media (such as LinkedIn). Prediction 4300 may therefore result in an issuer limiting its deployment of marketing resources through channels associated with the one form of social media and relatively increasing its deployment of marketing resources through channels associated with the other form of social media.

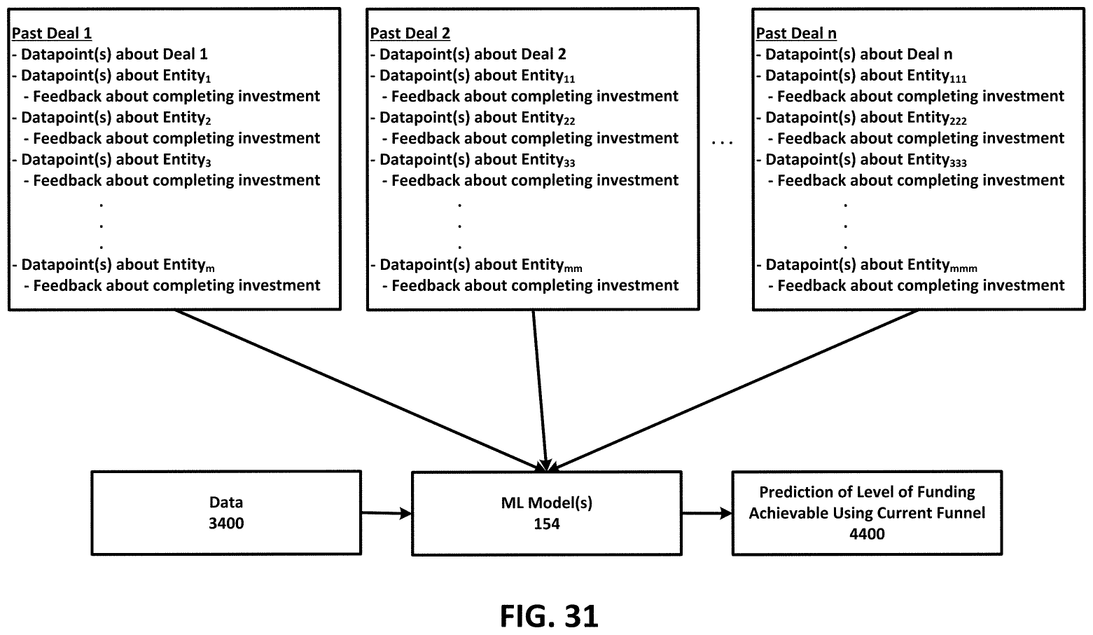

FIG. 31 is an example block diagram of training a machine learning model to output, based on data 3400 pertaining to one or more datapoints about each of multiple entities in a current group comprising an investment amount expressed by each entity and one or more datapoints about a deal, a prediction 4400 of a total amount of investment in the deal by the group of entities. One or more datapoints pertaining to each of a plurality of other deals, and one or more datapoints pertaining to each of a plurality of other entities associated with the other deals, and feedback about in which of the other deals the plurality of entities had completed an investment, and feedback about in which of the other deals the other entities had not completed an investment, may be received by server(s) 128. The one or more datapoints about other deals and the one or more datapoints about the other respective entities and about the feedback may be included in an input training dataset used to train machine learning model(s) 154. For example, machine learning model(s) 154 may be trained using this input data to identify similarities of the one or more datapoints about each of a plurality of entities in a group with other datapoints about other entities, and to identify similarities of the one or more datapoints about a new deal with other datapoints about other deals, and to produce a prediction 4400 about a total amount of investment by the group of entities. The machine learning model(s) 154 may produce a propensity score 4100 for each entity in the group, and based on the propensity score and each of the respective investment amounts expressed by the entities, may generate an entity predicted investment amount. The prediction 4400 may be a sum of the entity predicted investment amounts.

In embodiments, a prediction 4400 may include a number, such as a dollar value. In embodiments, a prediction 4400 may include a set of numbers, such as for example showing individual predicted investment amounts for each of the entities in the group. In an embodiment, prediction 4400 corresponding to a predicted total amount may be calculated as in Equations (2) and (3), below:

entity_predicted_amount=entity_propensity_score*entity_expressed_amount (2)

predicted_total_amount=Σ entity_predicted_amounts (3)

Such a prediction 4400 may thereafter be sold as a tangible asset, may be combined with other data to be sold together as a derivative tangible asset, and/or may be used during a subsequent process, such as input data to another of machine learning model(s) 154.

A prediction 4400 may be useful for enabling a user, such as the issuer of a deal, to predict whether a given group of entities—such as an existing marketing funnel—is more or less likely to together provide the issuer with the full investment amount for the deal. Certain entities in the marketing funnel may have engaged the deal differentially: some may have completed none of the deal questionnaire but have created a user profile in a deal portal based on an invitation, whereas others may have gone farther with the questionnaire including expressing (i.e. submitting to the deal portal, for example) a respective investment amount for the deal. Such entities in the marketing funnel may not have completed their investment in the deal. By providing a user with prediction 4400 based on a current marketing funnel of entities, the user may be able to assess whether the entities in the current marketing funnel represent—through their respective propensities to invest and their respect expressed investment amount—a sufficient amount of investment for the deal. If it is predicted that (in addition to any investments in the deal already completed) the current marketing funnel represents a sufficient amount of investment for the deal, the issuer may choose to cease or reduce expenditures or other resources on, or shift expenditures or other resources away from, marketing aimed at growing the funnel and perhaps increase focus on the entities in the current marketing funnel to improve the prospects of entities in the current marketing funnel completing their investment in the deal. If, on the other hand, it is predicted that (in addition to any investments in the deal already completed) the current marketing funnel does not represent a sufficient amount of investment for the deal, the issuer may choose to continue or increase expenditures or other resources on, or shift expenditures or other resources to, marketing aimed at growing the size of the marketing funnel itself and perhaps reduce focus on the entities in the current marketing funnel due to it being unlikely to be effective in assisting entities in the current marketing funnel completing their investment in the deal. It will be appreciated therefore that prediction 4400 may enable users to differentially value a current marketing funnel from a perhaps notional, larger, marketing funnel.

Prediction 4400 may therefore result in an issuer limiting its deployment of marketing and/or deal resources in one way and increasing its deployment of marketing and/or deal resources in another.

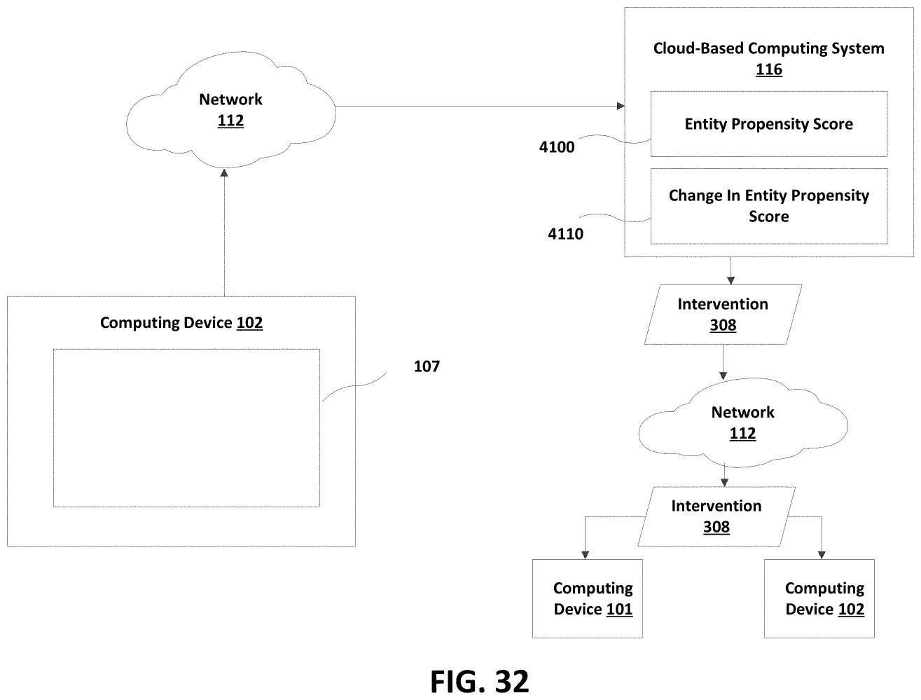

FIG. 32 illustrates an example block diagram of computing device 102 receiving one or more additional or modified datapoints about an entity and transmitting the one or more additional or modified datapoints about the entity to cloud-based computing system 116, according to certain embodiments of this disclosure. One or more additional or modified datapoints about an entity may be entity-deal datapoints codifying a change by the entity in the entity's relationship to the deal. For example, a user may, using user interface 107, modify entries in a questionnaire to change the number of units of a security, to change an address, or to make other changes. A user may progress to a subsequent stage of the questionnaire Tracking application 111 may have detected changes in behaviours of the user with respect to the deal portal, such as a threshold delay between interactions with the deal portal as compared with some baseline amount of delay, a user dwelling for a long time on a particular screen, or some other change in behaviour. The additional or modified datapoints about the entity may be provided to produce an updated propensity score 4100 or the entity. An initial propensity score and one or more updated propensity scores produced based on additional or modified datapoints about the entity being received at least once, may be compared to determine if an updated propensity score is at least a threshold amount different from the initial propensity score or from a previously-updated propensity score. Such a change in entity propensity score 4110 may inform automatic and/or user-operated interventions 308.

An entity may have been assigned, by cloud-based computing system 116, to an initial cohort of entities based on an initial propensity score of the entity. For example, an initial propensity score of the entity may be high, such that the entity is assigned to a high propensity score cohort. An updated propensity score for an entity being a threshold amount different from an initial propensity score or from a previously-updated propensity score may cause cloud-based computing system 116 to re-assign the entity to a second, different cohort. For example, an updated propensity score may be a threshold amount lower than the initial or previously-updated propensity score, such that the entity is re-assigned from a high propensity score cohort to a medium propensity score cohort. Alternatively, an updated propensity score may be a threshold amount higher than the initial or previously-updated propensity score that had the entity in a medium propensity score cohort, such that the entity is re-assigned from the medium propensity score cohort to a high propensity score cohort.

The differences between the one or more datapoints received about the entity and the one or more additional or modified datapoints received about the entity may be stored in cloud-based computing system 116 so that a user, such as an issuer, may delve into specific causes of any cohort re-assignments so that the specific causes may be dealt with if possible. For example, if a cause of a change in cohort for a particular entity has arisen because the entity is stalled at the payment stage, an issuer may be informed of this via user interface 105 of computing device 101, and the issuer may contact the entity by sending a message to the entity that can be accessed at computing device 102, such as via user interface 107 of computing device 102.

Entities may be assigned to cohorts for the purpose of enabling an issuer to address, through intervention 308, the cohort as a group or to help the issuer focus on certain entities in certain cohorts in particular ways appropriate to the deal resources available to the issuer and to any interventions 308 with the entities and the cohorts that may be beneficial and efficient to do. For example, entities in a high propensity cohort on a deal may be contacted individually, such as by telephone or email, to address any concerns or questions that the entities may have in completing their investment in the deal. Entities in a low propensity cohort on a deal may be messaged using mass emails, rather than individually. Entities in a medium cohort on a deal may be contacted individually based on the size of the investment that they have indicated they may make, but otherwise messaged using mass emails. The treatment of different cohorts and the individual entities within them may be at the discretion of the issuer. However, individuals in a lower-propensity cohort may generally be provided with less personal attention than individuals in a higher-propensity cohort, as the deal and marketing resources permit.

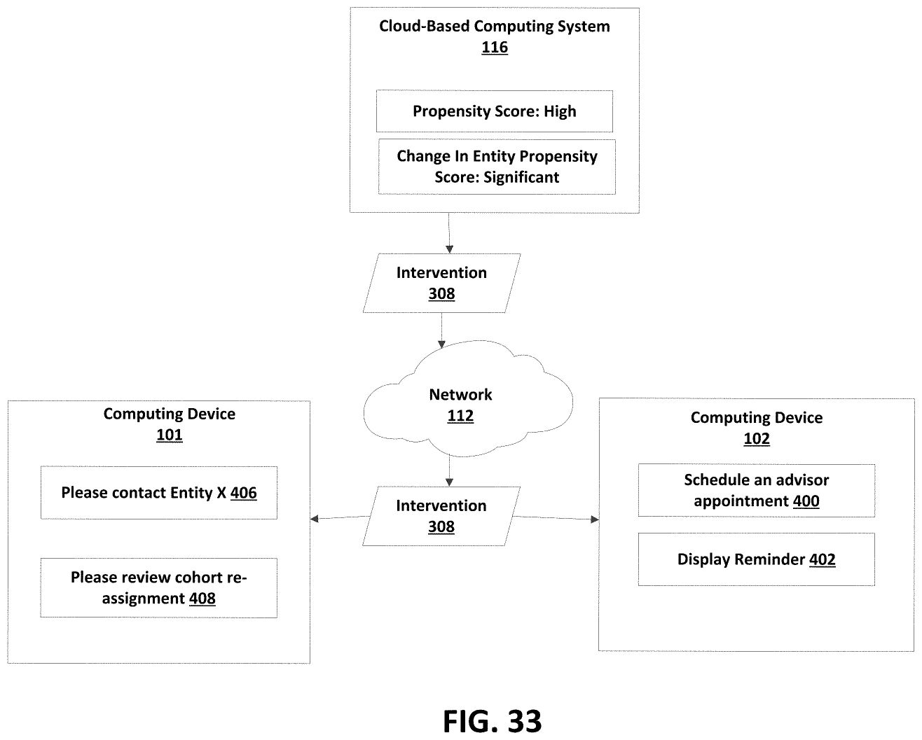

FIG. 33 illustrates an example block diagram of performing one or more interventions 308 according to certain embodiments of this disclosure. An intervention 308 may be triggered as a result of a propensity score for an entity being at or above a threshold level and/or as a result of a propensity score for an entity having changed more than a threshold amount i.e., significantly. An increase in propensity score may trigger an intervention 308 and/or a decrease in propensity score may trigger an intervention 308. An intervention 308 may take the form of a prompt sent to a user representing the issuer of the deal via computing device 101 to please contact a particular Entity X 406 and/or may take the form of a prompt sent to a user representing the issuer of the deal via computing device 101 to please review a cohort re-assignment 408. Other forms of intervention 308 via computing device 101 are possible.

An intervention 308 may take the form of a prompt sent to user who is or represents an entity via computing device 102 to please schedule an advisor appointment 400 and/or may take the form of display of a reminder 402 prompting the user who is or represents the entity to attend to the questionnaire, to payment, to execution of an investment/subscription agreement, to the upload of additional documents, and/or to some other aspect relating to completion of the entity's investment in the deal. Other forms of intervention 308 via computing device 102 are possible.

Machine learning models 154 may be trained with the training data to perform an intervention 308 based on the level of a determined current propensity score for an entity being at or exceeding a threshold amount and/or based on a change between an initial propensity score and an updated propensity score for an entity produced at different times exceeding a respective threshold.

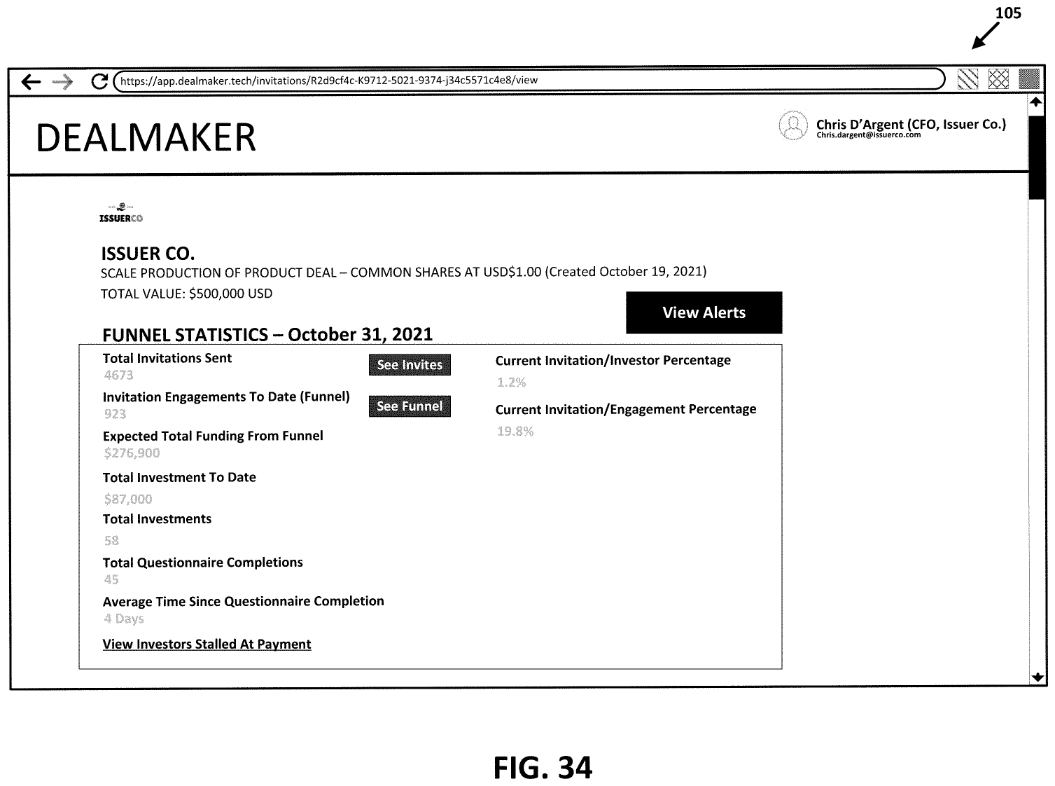

FIG. 34 illustrates user interface 105 showing user interface elements presented to a user of a computing device 101 enabling the user to, on behalf of an issuer, review a deal profile 202 for a deal hosted on the deal portal. User interface 105 includes user interface controls enabling the user to view entity invitations to the deal, a current funnel of entities associated with the deal, and/or a report on entities in the current funnel who may be stalled on executing payment for completing their investment.

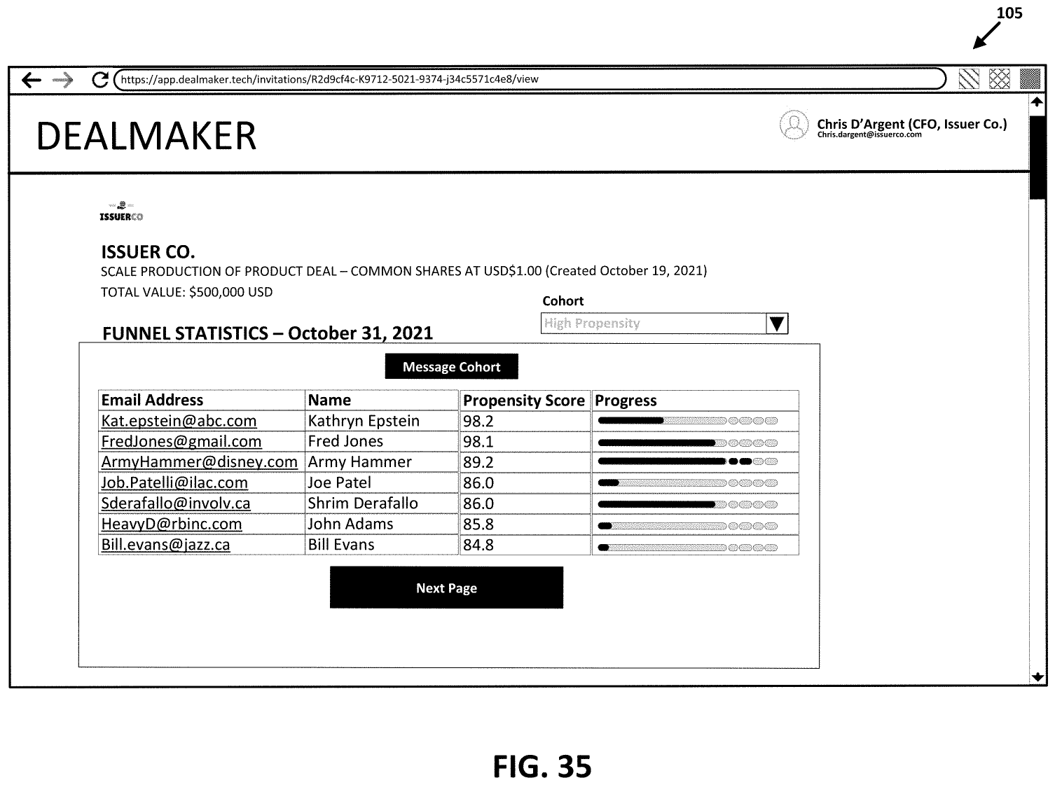

FIG. 35 illustrates user interface 105 showing user interface elements presented to a user of computing device 101 enabling the user to, on behalf of an issuer, view a high propensity cohort of a current funnel of entities associated with the deal, and a user interface control for enabling the user to message the high propensity cohort.

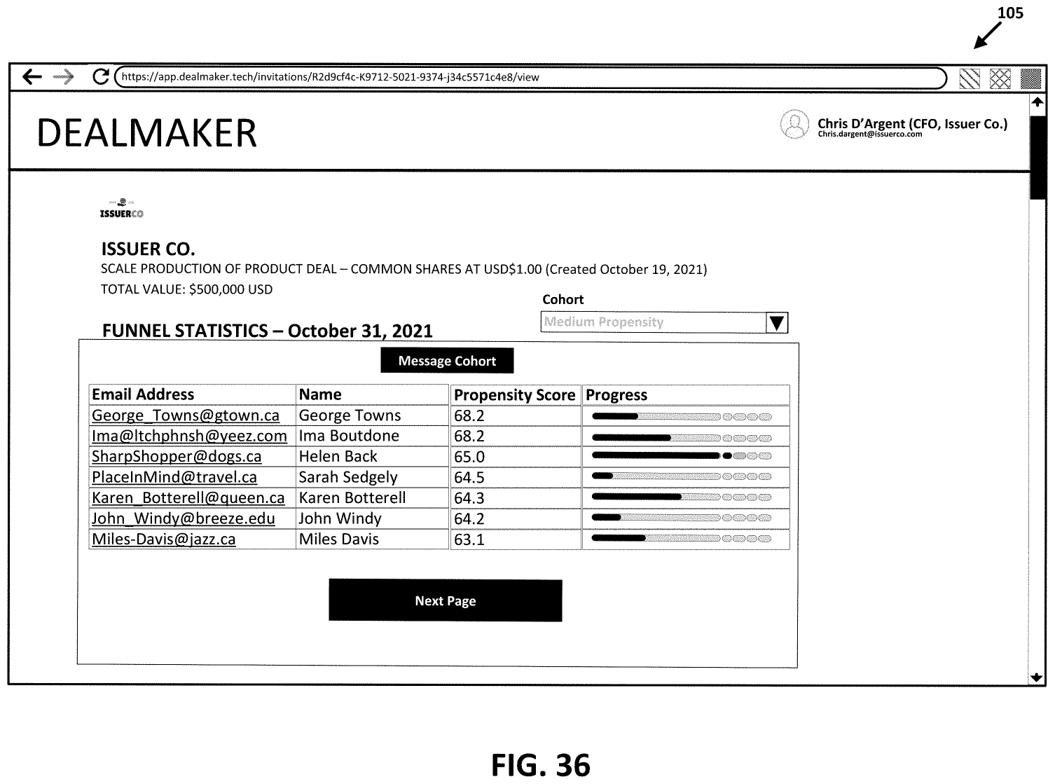

FIG. 36 illustrates a user interface 105 showing user interface elements presented to a user of computing device 101 enabling the user to, on behalf of an issuer, view a medium propensity cohort of a current funnel of entities associated with the deal, and a user interface control for enabling the user to message the medium propensity cohort.

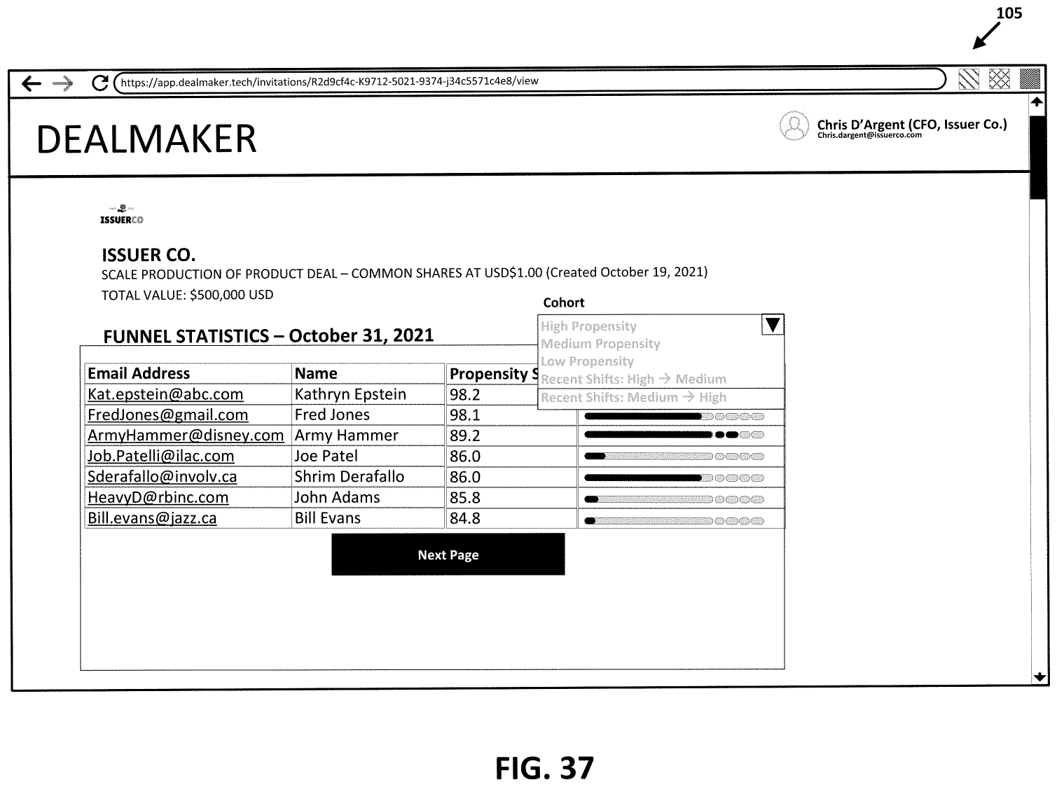

FIG. 37 illustrates a user interface 105 showing user interface elements and user interface controls presented to a user of computing device 101 enabling the user to, on behalf of an issuer, select a cohort of a current funnel of entities associated with the deal. A user may select a cohort of entities that have recently shifted, due to a change in respective propensity score, from a medium propensity cohort to a high propensity cohort. A user may select a cohort of entities that have recently shifted, due to a change in respective propensity score, from a high propensity cohort to a medium propensity cohort. Other selections may be provided.

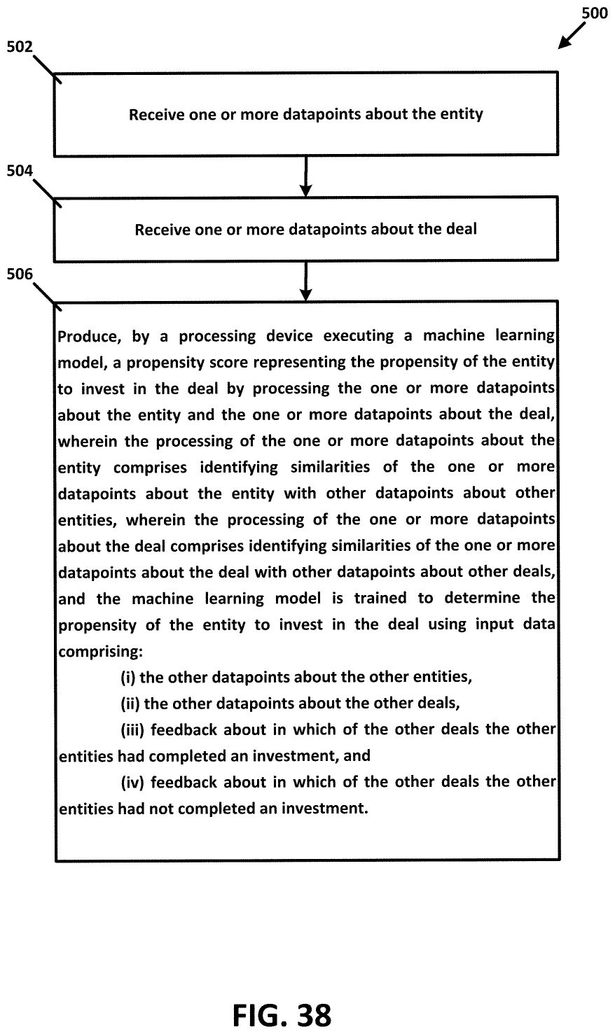

FIG. 38 illustrates steps in a method 500 for scoring a propensity of an entity to invest in a deal, according to embodiments. During method 500, one or more datapoints about the entity are received (step 502) and one or more datapoints about the deal are received (step 504). Method 500 proceeds to produce, by a processing device executing a machine learning model, a propensity score representing the propensity of the entity to invest in the deal by processing the one or more datapoints about the entity and the one or more datapoints about the deal, wherein the processing of the one or more datapoints about the entity comprises identifying similarities of the one or more datapoints about the entity with other datapoints about other entities, wherein the processing of the one or more datapoints about the deal comprises identifying similarities of the one or more datapoints about the deal with other datapoints about other deals. The machine learning model is trained to determine the propensity of the entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment (step 506).

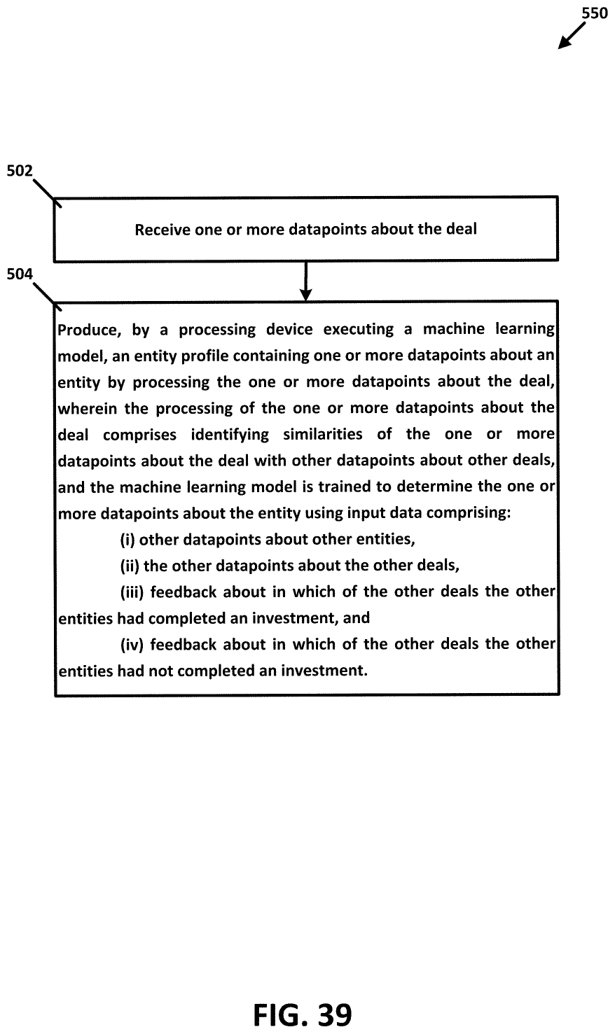

FIG. 39 illustrates steps in a method 550 for generating a profile of an entity with a high propensity to invest in a deal, according to embodiments. During method 550, one or more datapoints about the deal are received (step 500). Method 550 proceeds to produce, by a processing device executing a machine learning model, an entity profile containing one or more datapoints about an entity by processing the one or more datapoints about the deal, wherein the processing of the one or more datapoints about the deal comprises identifying similarities of the one or more datapoints about the deal with other datapoints about other deals, and the machine learning model is trained to determine the one or more datapoints about the entity using input data comprising: (i) other datapoints about other entities, (ii) the other datapoints about the other deals, (iii) feedback about in which of the other deals the other entities had completed an investment, and (iv) feedback about in which of the other deals the other entities had not completed an investment (step 504).

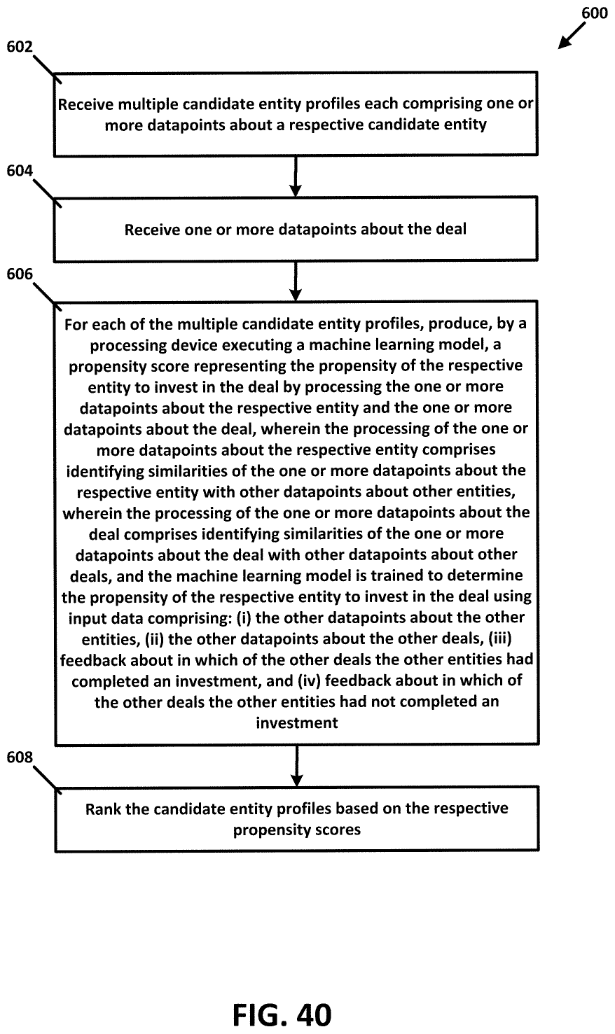

FIG. 40 illustrates steps in a method 600 for ranking candidate entity profiles based on propensity to invest in a deal, according to embodiments. During method 600, multiple candidate entity profiles each comprising one or more datapoints about a respective candidate entity are received (step 602) and one or more datapoints about the deal are received (step 604). The method 600 proceeds to, for each of the multiple candidate entity profiles, produce, by a processing device executing a machine learning model, a propensity score representing the propensity of the respective entity to invest in the deal by processing the one or more datapoints about the respective entity and the one or more datapoints about the deal, wherein the processing of the one or more datapoints about the respective entity comprises identifying similarities of the one or more datapoints about the respective entity with other datapoints about other entities, wherein the processing of the one or more datapoints about the deal comprises identifying similarities of the one or more datapoints about the deal with other datapoints about other deals, and the machine learning model is trained to determine the propensity of the respective entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment (step 606). The method 600 proceeds to rank the candidate entity profiles based on the respective propensity scores (step 608).

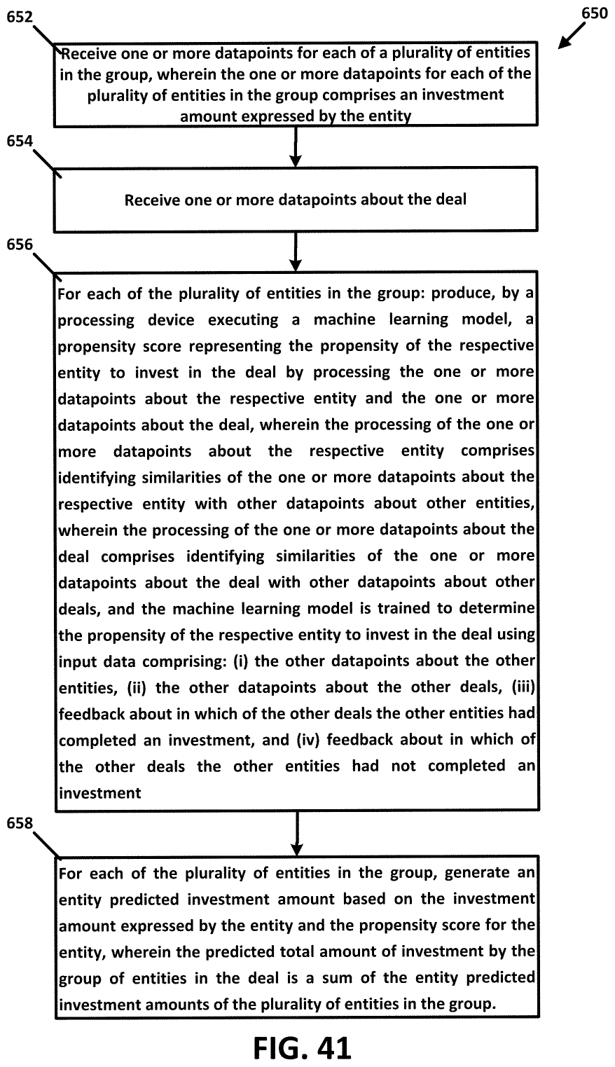

FIG. 41 illustrates steps in a method 650 for predicting a total amount of investment in a deal by a group of entities, according to embodiments. During method 650, one or more datapoints for each of a plurality of entities in the group, wherein the one or more datapoints for each of the plurality of entities in the group comprises an investment amount expressed by the entity, are received (step 652) and one or more datapoints about the deal are received (step 654). The method 650 proceeds to, for each of the plurality of entities in the group produce, by a processing device executing a machine learning model, a propensity score representing the propensity of the respective entity to invest in the deal by processing the one or more datapoints about the respective entity and the one or more datapoints about the deal, wherein the processing of the one or more datapoints about the respective entity comprises identifying similarities of the one or more datapoints about the respective entity with other datapoints about other entities, wherein the processing of the one or more datapoints about the deal comprises identifying similarities of the one or more datapoints about the deal with other datapoints about other deals, and the machine learning model is trained to determine the propensity of the respective entity to invest in the deal using input data comprising: (i) the other datapoints about the other entities, (ii) the other datapoints about the other deals, (iii) feedback about in which of the other deals the other entities had completed an investment, and (iv) feedback about in which of the other deals the other entities had not completed an investment (step 656). The method 650 proceeds to, for each of the plurality of entities in the group, generating an entity predicted investment amount based on the investment amount expressed by the entity and the propensity score for the entity, wherein the predicted total amount of investment by the group of entities in the deal is a sum of the entity predicted investment amounts of the plurality of entities in the group.

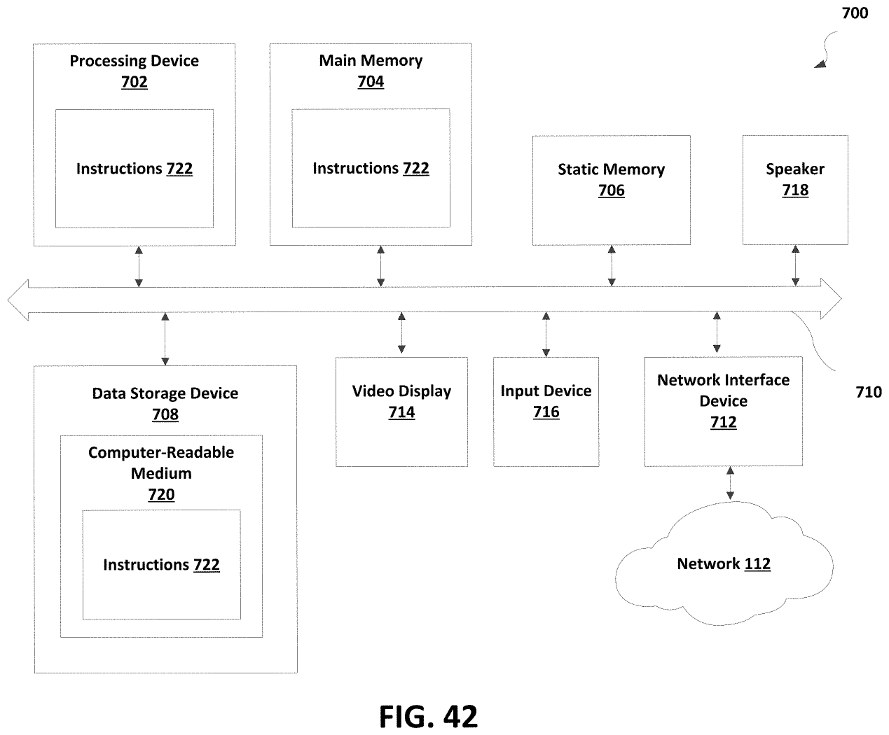

FIG. 42 illustrates an example computer system 700, which can perform any one or more of the methods described herein. In one example, computer system 700 may correspond to the computing device 101, the computing device 102, one or more servers 128 of the cloud-based computing system 116, the electronic device 150, or one or more training engines 152 of the cloud-based computing system 16 of FIG. 1. The computer system 700 may be capable of executing the user interface 105, the tracking application 111, or the third party application 107 of FIG. 1. The computer system 700 may be connected (e.g., networked) to other computer systems in a LAN, an intranet, an extranet, or the Internet. The computer system 700 may operate in the capacity of a server in a client-server network environment. The computer system 700 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 700 includes a processing device 702, a main memory 704 (e.g., read-only memory (ROM), solid state drive (SSD), flash memory, dynamic random access memory (DRAM) such as synchronous DRAM (SDRAM)), a static memory 706 (e.g., solid state drive (SSD), flash memory, static random access memory (SRAM)), and a data storage device 708, which communicate with each other via a bus 710.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions for performing any of the operations and steps discussed herein.

The computer system 700 may further include a network interface device 712. The computer system 700 also may include a video display 714 (e.g., a liquid crystal display (LCD) or a cathode ray tube (CRT)), one or more input devices 716 (e.g., a keyboard and/or a mouse), and one or more speakers 718 (e.g., a speaker). In one illustrative example, the video display 714 and the input device(s) 716 may be combined into a single component or device (e.g., an LCD touch screen).

The data storage device 716 may include a computer-readable medium 720 on which the instructions 722 (e.g., implementing the application programming interface 135, the user interface 105, the tracking application 111, the third party application 107, and/or any component depicted in the FIGURES and described herein) embodying any one or more of the methodologies or functions described herein are stored. The instructions 722 may also reside, completely or at least partially, within the main memory 704 and/or within the processing device 702 during execution thereof by the computer system 700. As such, the main memory 704 and the processing device 702 also constitute computer-readable media. The instructions 722 may further be transmitted or received over a network via the network interface device 712.

While the computer-readable storage medium 720 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although embodiments have been described, those of skill in the art will appreciate that variations and modifications may be made without departing from the spirit, scope and purpose of the invention as defined by the appended claims.

What is claimed is:

1. A method for scoring a propensity of an entity to invest in a deal, the method comprising:
receiving one or more datapoints about the entity;
receiving one or more datapoints about the deal; and
producing, by a processing device executing a machine learning model, a propensity score representing the propensity of the entity to invest in the deal by processing the one or more datapoints about the entity and the one or more datapoints about the deal, wherein the processing of the one or more datapoints about the entity comprises identifying similarities of the one or more datapoints about the entity with other datapoints about other entities, wherein the processing of the one or more datapoints about the deal comprises identifying similarities of the one or more datapoints about the deal with other datapoints about other deals, and the machine learning model is trained to determine the propensity of the entity to invest in the deal using input data comprising:
(i) the other datapoints about the other entities,
(ii) the other datapoints about the other deals,
(iii) feedback about in which of the other deals the other entities had completed an investment, and
(iv) feedback about in which of the other deals the other entities had not completed an investment.

2. The method of claim 1, wherein each of the one or more datapoints about the entity is respectively one of: a demographic datapoint, a personal datapoint, an investment history datapoint, and an entity-deal datapoint.

3. The method of claim 2, wherein each demographic datapoint is respectively one of: a location, whether the entity is an organization or an individual, an age, a date of birth, and a gender.

4. The method of claim 2, wherein each personal datapoint is respectively one of: an email domain, a risk aversion level, an investment aim, a net worth, an income, whether the entity is an accredited investor, and whether the entity is eligible to make a particular class of investment.

5. The method of claim 2, wherein each investment history datapoint is respectively one of: whether the entity has invested before, a type of prior investment, an amount of prior investment, a type of prior investment passed on, and a number of investment deals to which the entity has previously been invited.

6. The method of claim 2, wherein each entity-deal datapoint is respectively one of: whether the entity was invited to consider the deal, at what stage in closing the deal the entity has reached, an entity relationship to an issuer of the deal, in how many saleable units of the deal the entity has expressed interest, whether the entity has invested in the issuer of the deal, whether the entity has a broker for the deal, a number of past issuances dealt with using the broker, a payment method for the deal, and a deal portal interaction datapoint.

7. The method of claim 6, wherein each deal portal interaction datapoint is respectively one of: a time spent by a user reviewing the deal via a network-accessible deal portal, a time spent by the user reviewing particular aspects of the deal via the deal portal, a time delay between completing stages of a deal questionnaire via the deal portal, a time of day at which the user has accessed the deal portal, and a frequency with which the user has accessed the deal portal.

8. The method of claim 1, comprising:
generating, for presentation on a computing device, a user interface element including a representation of the propensity score in association with identifying information about the entity.

9. The method of claim 1, comprising:
assigning the entity to a first cohort based at least in part on the propensity score.

10. The method of claim 9, comprising:
generating, for presentation on a computing device, a user interface element including an identification of entities as being assigned to the first cohort.

11. The method of claim 10, comprising:
providing, as part of the user interface element, a user interface control for enabling messaging of one or more entities assigned to the first cohort.

12. The method of claim 9, comprising at least once:
receiving one or more additional or modified datapoints about the entity; and
repeating the producing using the one or more additional or modified datapoints thereby to produce an updated propensity score.

13. The method of claim 12, comprising:
responsive to the updated propensity score being at least a threshold amount different from the propensity score or a previous updated propensity score, re-assigning the entity to a second cohort.

14. The method of claim 13, wherein entities assigned to the second cohort have higher propensities to invest in the deal than entities assigned to the first cohort.

15. The method of claim 13, wherein entities assigned to the first cohort have higher propensities to invest in the deal than entities assigned to the second cohort.

16. The method of claim 13, comprising:
responsive to the re-assigning, generating, for presentation on a computing device, a report about the re-assigning.

17. The method of claim 16, wherein the report about the re-assigning comprises information derived from one or more differences between values of the one or more additional or modified datapoints about the entity and the one or more datapoints about the entity, thereby to emphasize cause(s) of the re-assigning to the second cohort.

18. A method for generating a profile of an entity with a high propensity to invest in a deal, the method comprising:
receiving one or more datapoints about the deal; and
producing, by a processing device executing a machine learning model, an entity profile containing one or more datapoints about an entity by processing the one or more datapoints about the deal, wherein the processing of the one or more datapoints about the deal comprises identifying similarities of the one or more datapoints about the deal with other datapoints about other deals, and the machine learning model is trained to determine the one or more datapoints about the entity using input data comprising:
(i) other datapoints about other entities,
(ii) the other datapoints about the other deals,
(iii) feedback about in which of the other deals the other entities had completed an investment, and
(iv) feedback about in which of the other deals the other entities had not completed an investment.

19. The method of claim 18, wherein at least one of the one or more datapoints about the entity is a range of values.

20. A method for ranking candidate entity profiles based on propensity to invest in a deal, the method comprising:
receiving multiple candidate entity profiles each comprising one or more datapoints about a respective candidate entity;
receiving one or more datapoints about the deal; and
for each of the multiple candidate entity profiles:
producing, by a processing device executing a machine learning model, a propensity score representing the propensity of the respective entity to invest in the deal by processing the one or more datapoints about the respective entity and the one or more datapoints about the deal, wherein the processing of the one or more datapoints about the respective entity comprises identifying similarities of the one or more datapoints about the respective entity with other datapoints about other entities, wherein the processing of the one or more datapoints about the deal comprises identifying similarities of the one or more datapoints about the deal with other datapoints about other deals, and the machine learning model is trained to determine the propensity of the respective entity to invest in the deal using input data comprising:
(i) the other datapoints about the other entities,
(ii) the other datapoints about the other deals,
(iii) feedback about in which of the other deals the other entities had completed an investment, and
(iv) feedback about in which of the other deals the other entities had not completed an investment;
the method further comprising:
ranking the candidate entity profiles based on the respective propensity scores.

21. A method for predicting a total amount of investment in a deal by a group of entities, the method comprising:
receiving one or more datapoints for each of a plurality of entities in the group, wherein the one or more datapoints for each of the plurality of entities in the group comprises an investment amount expressed by the entity;
receiving one or more datapoints about the deal; and
for each of the plurality of entities in the group:
producing, by a processing device executing a machine learning model, a propensity score representing the propensity of the respective entity to invest in the deal by processing the one or more datapoints about the respective entity and the one or more datapoints about the deal, wherein the processing of the one or more datapoints about the respective entity comprises identifying similarities of the one or more datapoints about the respective entity with other datapoints about other entities, wherein the processing of the one or more datapoints about the deal comprises identifying similarities of the one or more datapoints about the deal with other datapoints about other deals, and the machine learning model is trained to determine the propensity of the respective entity to invest in the deal using input data comprising:
(i) the other datapoints about the other entities,
(ii) the other datapoints about the other deals,
(iii) feedback about in which of the other deals the other entities had completed an investment, and
(iv) feedback about in which of the other deals the other entities had not completed an investment;
the method further comprising:
for each of the plurality of entities in the group, generating an entity predicted investment amount based on the investment amount expressed by the entity and the propensity score for the entity,
wherein the predicted total amount of investment by the group of entities in the deal is a sum of the entity predicted investment amounts of the plurality of entities in the group.
